(19) United States
(12) Patent Application Publication
(10) Pub. No.: US 2025/0094916 A1
(43) Pub. Date: Mar. 20, 2025

(54) SYSTEM INCLUDING A SERVER SYSTEM, A PLURALITY OF GATEWAYS AND A DEVICE

(71) Applicant: Moeco IoT Inc.

(72) Inventors: Dmitry GORILOVSKY, Berlin (DE); Ilia ASTAFEV, Sunnyvale, CA (US); Aleksey DOLGUSHIN, Sunnyvale, CA (US); Anton KUROPYATNIK, Sunnyvale, CA (US); Andrei KORYTTSEV, Sunnyvale, CA (US); Oleksandra SYNIACHEVA, Sunnyvale, CA (US)

(21) Appl. No.: 17/771,464

(22) PCT Filed: Oct. 23, 2020
(86) PCT No.: PCT/US2020/056986

§ 371 Date: Apr. 23, 2022

(30) Foreign Application Priority Data
Oct. 23, 2019 (GB) 1915385.7

(51) Int. Cl. G06Q 10/0833; H04L 12/66

(52) U.S. Cl. CPC G06Q 10/0833; H04L 12/66

(57) ABSTRACT

System for tracking a life cycle of a device, including a server system, a plurality of gateways and the device, the device configured to sense and to transmit sensory data, the device including a sensor and a transmitter, wherein the server system is configured to receive transmissions from the device via any gateway of the plurality of gateways, the transmissions including a device ID of the device, the server system storing a tracking record of the device in association with the device ID, wherein the server system is configured to update the stored tracking record of the device in relation to: (i) production of the device, in response to receiving a respective communication from the device; and (ii) storage or sale of the device, in response to receiving a respective communication from the device; and (iii) usage of the device, in response to receiving a respective communication from the device.

### BACKGROUND OF THE INVENTION

### 1. Field of the Invention

The field of the invention relates to systems including a server system, a plurality of gateways and a device, and to devices which may form part of the system, and which may be tracked using the system.

### 2. Technical Background

At the present time, the world contains billions of devices with connectivity which gather sensor data. It would be possible to gather up that data in a particular location, and to store that data, and then to analyze the stored data to obtain results which cannot otherwise be obtained. However, when there are so many devices with connectivity which gather sensor data, there is the question of how an adverse impact on the environment of such a large number of devices can be managed. There is also the question of whether the whereabouts and/or life cycle status of such a large number of devices can be ascertained.

### 3. Discussion of Related Art

WO2018232221A1 discloses a system including a data storage server, a service provider's server, and a gateway, the service provider's server in communication with the data storage server, and the gateway in communication with the data storage server, wherein the data storage server is configured to generate first tokens, to receive a registration from the service provider's server, and to issue first tokens to the service provider's server, and to receive a first token from the service provider's server, wherein the data storage server is configured to receive sensor data from the gateway, the gateway arranged to receive the sensor data from a device registered at the service provider's server, the data storage server configured to issue second tokens to the gateway after receiving the sensor data from the gateway, the data storage server further configured to store the received sensor data on the data storage server or to store the received sensor data on the service provider's server, wherein the sensor data is stored using a blockchain system, wherein token transactions for the first tokens and for the second tokens are stored using the blockchain system, and wherein the data storage server, the service provider's server, and the gateway are registered nodes in the blockchain system. WO2018232221A1 is incorporated by reference.

WO2019070619A1 discloses a system including a data storage server, a service provider's server, and a gateway including a transceiver configured to operate at a power level below 5.0 mW, the gateway programmed with an application, the service provider's server in communication with the data storage server, and the gateway in communication with the data storage server, wherein the data storage server is configured to generate first tokens, to receive a registration from the service provider's server, and to issue first tokens to the service provider's server, and to receive a first token from the service provider's server, wherein the data storage server is configured to receive sensor data from the gateway, the gateway executing the application to receive the sensor data from a sensor, or from a plurality of sensors, via the transceiver, the data storage server configured to issue second tokens to the gateway after receiving the sensor data from the gateway, the data storage server further configured to store the received sensor data on the data storage server or to store the received sensor data on the service provider's server, wherein token transactions for the first tokens and for the second tokens are stored in the system. A related method is also disclosed. WO2019070619A1 is incorporated by reference.

### SUMMARY OF THE INVENTION

According to a first aspect of the invention, there is provided a system for tracking a life cycle of a device, the system including a server system, a plurality of gateways and the device, the device configured to sense and to transmit sensory data, the device including a sensor and a transmitter, wherein the server system is configured to receive transmissions from the device via any gateway of the plurality of gateways, the transmissions including a device ID of the device, the server system storing a tracking record of the device in association with the device ID, wherein the server system is configured to update the stored tracking record of the device in relation to:
(i) production of the device, in response to receiving a respective communication from the device; and
(ii) storage or sale of the device, in response to receiving a respective communication from the device; and
(iii) usage of the device, in response to receiving a respective communication from the device.

An advantage of the invention is that the device is tracked very thoroughly. An advantage of the invention is that the device sensory data is tracked very thoroughly. An advantage of the invention is that the stage of the device in its life cycle is determined accurately.

The system may be one wherein the server system is configured to update the stored tracking record of the device in relation to: (i) production of the device, in response to receiving a respective communication from the device, via a gateway associated with device production. An advantage is that device production is tracked very thoroughly.

The system may be one wherein the server system is configured to update the stored tracking record of the device in relation to: (ii) storage or sale of the device, in response to receiving a respective communication from the device, via a gateway associated with storage or sale of the device. An advantage is that device storage or sale is tracked very thoroughly.

The system may be one wherein the server system is configured to update the stored tracking record of the device in relation to: (iii) usage of the device, in response to receiving a respective communication from the device, via a gateway associated with, or inferred to relate to, device usage. An advantage is that device usage is tracked very thoroughly.

The system may be one wherein the server system is configured to update the stored tracking record of the device in relation to:
(iv) recycling or decommissioning of the device, in response to receiving a respective communication from the device. An advantage of the invention is that the stage of the device in its life cycle is determined accurately.

The system may be one wherein the server system is configured to update the stored tracking record of the device in relation to: (iv) recycling or decommissioning of the device, in response to receiving a respective communication from the device, via a gateway associated with device recycling or decommissioning. An advantage is that device recycling or decommissioning is tracked very thoroughly.

The system may be one wherein the device transmitter is configured to transmit sensory data using any one, or more, or all, of the following technologies for data transfer: WiFi, Bluetooth, low-power wide-area network (LPWAN) or Global System for Mobile Communications (GSM)/Narrowband Internet of Things (NB-IoT). An advantage is that communication from the device to the server system is facilitated.

The system may be one wherein a gateway is configured to receive sensory data using any one, or more, or all, of the following technologies for data transfer: WiFi, Bluetooth, low-power wide-area network (LPWAN) or Global System for Mobile Communications (GSM)/Narrowband Internet of Things (NB-IoT). An advantage is that communication from the device to the server system is facilitated.

The system may be one wherein transmitted data is aggregated by the gateways, wherein the gateways then transfer data to the server system.

The system may be one wherein the server system receives data from the gateways, through middleware.

The system may be one wherein the device includes a plurality of sensors.

The system may be one wherein sensory data is generated by different physical sensors in the device.

The system may be one wherein the device includes a PCB. An advantage is improved device reliability.

The system may be one wherein the device includes a battery.

The system may be one wherein the device includes a processor.

The system may be one wherein the server system provides access to sensory data it has received. An advantage is that emergency services may be able to respond more effectively due to ready access to the sensory data.

The system may be one wherein the server system provides the access to the sensory data it has received, through application programming interface (API) interfaces.

The system may be one wherein a gateway is a smartphone, programmed with an application. An advantage is that area coverage of gateways is improved.

The system may be one wherein a gateway is one which supports connectable modes of data transfer.

The system may be one wherein a gateway is one which supports non-connectable modes of data transfer.

The system may be one including a device configured to sense and to transmit sensory data, the device including a Bluetooth interface, the device configured to send data using the Bluetooth interface to a Bluetooth gateway that forwards data to the server system.

The system may be one including a device configured to sense and to transmit sensory data, and configured with LoRa (Long Range) technology, and configured to send data to LPWAN gateways, that forward data to the server system.

The system may be one including a device configured to sense and to transmit sensory data, the device supporting WiFi communications, the device configured to send data via a regular WiFi router, or using premises-based software gateways, that forward data to the server system.

The system may be one including a device configured to sense and to transmit sensory data, the device supporting GSM and/or Narrow Band communications, the device configured to send data to a mobile operator's cloud which is also connected to the server system.

The system may be one wherein the device configured to sense and to transmit sensory data is a portable device. An advantage is that a wider coverage of sensory data is obtained.

The system may be one wherein the device configured to sense and to transmit sensory data is a handheld device. An advantage is that a wider coverage of sensory data is obtained.

The system may be one wherein the device configured to sense and to transmit sensory data includes a touch screen.

The system may be one including a plurality of sensor devices which collect sensor data (e.g. temperature, location or acceleration data), and which transmit the collected data to gateways e.g. via one or more of WiFi, Bluetooth, LPWAN or GSM/NB-IoT communications. An advantage is that a wider and broader coverage of sensory data is obtained.

The system may be one wherein gateways transmit the received collected data to the server system, wherein the server system comprises a gateway API, a synchronization server and a database server, wherein the gateways transmit the received collected data to the gateway API, which stores the received data using a blockchain system using the synchronization server, where the data is then stored as a structured query language (SQL) database (DB) on a database server. An advantage is that reliability of the sensor data is improved. An advantage is that the stored sensor data is stored safely from malicious parties.

The system may be one wherein the server system performs integrations to payments gateways.

The system may be one wherein the server system includes APIs eg. to a cloud system, to a custom system, or to provide data views.

The system may be one wherein the APIs eg. to a cloud system, to a custom system, or to provide data views, connect to 3^{rd} side data analysis engines, or to stand alone solutions.

The system may be one wherein the server system provides a web view in connection with a web application. An advantage is that sensor data may be communicated publicly in an emergency scenario.

The system may be one wherein the server system is configured such that during data processing, the server system recognizes a life cycle stage of the sensor which sent the data. An advantage is that the stage of the device in its life cycle is determined accurately.

The system may be one wherein the server system is configured to track a full life cycle of a device. An advantage is that the stage of the device in its life cycle is determined accurately.

The system may be one wherein the server system is configured to customize the life cycle stages of a device.

The system may be one including a newly-produced device, configured to sense and to transmit sensory data, which is configured such that after power-up, the device communicates with a local gateway, and provides a unique device ID in a communication via the gateway. An advantage is that device production is tracked very thoroughly.

The system may be one wherein the newly-produced device communicates a location.

An advantage is that device production is tracked very thoroughly.

The system may be one wherein the communicated location is used by the server system to establish, or to confirm, that the device is newly produced. An advantage is that device production is tracked very thoroughly.

The system may be one wherein the gateway sends a transmission to the server system, wherein the transmission identifies the gateway.

The system may be one wherein the server system is configured to identify the newly produced device using its unique device ID, and a record at the server system is created, or is updated, for tracking this newly produced device through its life cycle.

The system may be one wherein the identity of the gateway is used to establish, or to confirm, that the device is newly produced.

The system may be one wherein the device is configured (e.g. programmed) to communicate that it is newly-produced, or newly manufactured.

The system may be one wherein the device configured to sense and to transmit sensory data communicates with a local gateway, and provides its unique device ID in a communication via the gateway.

The system may be one wherein the device communicates a location.

The system may be one wherein the communicated location is used to establish, or to confirm, that the device is at a place of storage, or at a place of sale. An advantage is that device storage or sale is tracked very thoroughly.

The system may be one wherein the gateway sends a transmission to the server system, wherein the transmission may identify the gateway. An advantage is that device storage or sale is tracked very thoroughly.

The system may be one wherein the server system identifies the device using its unique device ID, and its previously created record for tracking this device through its life cycle is updated.

The system may be one wherein the identity of the gateway is used to establish, or to confirm, that the device is at a place of storage, or at a place of sale.

The system may be one wherein the device is configured (e.g. programmed) to communicate that it is being stored, or is being put on sale.

The system may be one wherein the communicated location is used to establish, or to confirm, that the device is no longer at a place of storage, or at a place of sale, or at a place of manufacture, and hence it is now being used, and hence the record for tracking this device is updated to reflect that it is being used. An advantage is that device usage is tracked very thoroughly.

The system may be one wherein the gateway sends a transmission to the server system, wherein the transmission identifies the gateway. An advantage is that device usage is tracked very thoroughly.

The system may be one wherein the server system identifies the device using its unique device ID, and its previously created record for tracking this device through its life cycle is updated. An advantage is that device usage is tracked very thoroughly.

The system may be one wherein the identity of the gateway is used to establish, or to confirm, that the device is no longer at a place of storage, or at a place of sale, or at a place of manufacture, and hence it is now being used, and hence the record for tracking this device is updated to reflect that it is being used.

The system may be one wherein the device is configured (e.g. programmed) to communicate that it is being used.

The system may be one wherein the communicated location is used to establish, or to confirm, that the device is at a recycling location or at a decommissioning location, and hence it is now being recycled or decommissioned, and hence the record for tracking this device is updated to reflect that it is being recycled or decommissioned. An advantage is that device recycling or decommissioning is tracked very thoroughly.

The system may be one wherein the server system identifies the device using its unique device ID, and its previously created record for tracking this device through its life cycle is updated.

The system may be one wherein the identity of the gateway is used to establish, or to confirm, that the device is at a recycling location or at a decommissioning location, and hence it is now being recycled or decommissioned, and hence the record for tracking this device is updated to reflect that it is being recycled or decommissioned. An advantage is that device recycling or decommissioning is tracked very thoroughly.

The system may be one wherein the device is configured (e.g. programmed) to communicate that it is being recycled or decommissioned.

The system may be one wherein the server system provides a user interface in which data is displayed relating to tracking the life cycle of a product, e.g. from production to storing, selling, using and then to recycling, of the product. An advantage of the invention is that the device is tracked very thoroughly.

According to a second aspect of the invention, there is provided a logistic sensor device, the device including a temperature sensor, a light intensity sensor or sensors, and an acceleration sensor, the device configured to make sensory measurements using its sensors, the measurements including a temperature measurement using the temperature sensor, a light intensity measurement using the light intensity sensor, and an acceleration measurement, using the acceleration sensor, wherein the device is configured to send sensor data to a server. An advantage is that improved logistics tracking is provided.

The logistic sensor device may further include one or more or all of: a position sensor e.g. GPS position sensor, a humidity sensor, a sensor to detect that a seal is broken.

The logistic sensor device may be configured to make sensory measurements using its sensors, the measurements including one or more or all of: position measurement using position sensor e.g. GPS position sensor; humidity measurement using humidity sensor; using the sensor to detect that the seal is broken, wherein the device is configured to send sensor data to a server.

The logistic sensor device may be one wherein the logistic sensor device is a sticker-like device.

The logistic sensor device may be one wherein the logistic sensor device includes a customizable alarm that depends on the logistic sensor device's current condition.

The logistic sensor device may be one wherein the logistic sensor is configured to determine if a receiver is available for transmitting as-yet not transmitted sensor data to a server, and if one is available then available and/or stored data is sent to the server.

The logistic sensor device may be one wherein the logistic sensor is configured to determine if a receiver is available for transmitting as-yet not transmitted sensor data to a server, and if one is not available then the sensory data is stored in memory of the logistic sensor device.

The system of any aspect of the first aspect of the invention may be one wherein the device configured to sense and to transmit sensory data is a logistic sensor device of any aspect of the second aspect of the invention.

According to a third aspect of the invention, there is provided a bottle cap sensor device, the device including a temperature sensor, a light intensity sensor or sensors, and an acceleration sensor, the device configured to make sensory measurements using its sensors, the measurements including a temperature measurement using the temperature sensor, a light intensity measurement using the light intensity sensor, and an acceleration measurement, using the acceleration sensor, wherein the device is configured to send sensor data to a server. An advantage is that improved tracking of bottle environment provided.

The device may be one further including one or more or all of: humidity sensor, a sensor to detect movement and/or openings/closings of the cap.

The device may be one further including a position sensor e.g. GPS position sensor.

The device may be configured to make sensory measurements using its sensors, the measurements including one or more or all of: position measurement using position sensor e.g. GPS position sensor; humidity measurement using humidity sensor; using the sensor to detect movement and/or openings/closings of the cap, wherein the device is configured to send sensor data to a server.

The device may be one wherein the bottle cap sensor device includes a PCB with sensors onboard, which logs data about its storage conditions and whole life cycle.

The device may be one wherein the bottle cap sensor device includes a (e.g. plastic) bottle cap housing (e.g. a screw cap), a PCB including sensors, a battery, and a lower seal.

The system of any aspect of the first aspect of the invention may be one wherein the device configured to sense and to transmit sensory data is a bottle cap sensor device of any aspect of the third aspect of the invention.

According to a fourth aspect of the invention, there is provided a pipe sensor device, the device including a temperature sensor, and a vibration sensor, the device configured to make sensory measurements using its sensors, the measurements including a temperature measurement using the temperature sensor, and a vibration measurement, using the vibration sensor, wherein the device is configured to determine if measured data is such that it indicates pipe damage, and therefore a user alert needs to be sent, and if measured data is such that a user alert needs to be sent, then a user alert is sent.

The pipe sensor device may be one wherein the pipe sensor is fixable to a pipe external surface and does not require pipe dismantling.

The system of any aspect of the first aspect of the invention may be one wherein the device configured to sense and to transmit sensory data is a pipe sensor device of any aspect of the fourth aspect of the invention.

According to a fifth aspect of the invention, there is provided a security seal sensor device including a seal, the device including one or more sensors, the security seal sensor arranged to make sensory measurements using its sensors, the measurements checking if the seal was broken, wherein if measured data is such that the seal is determined to be broken, then a user alert is sent.

The device may be one including a time measurer, wherein the alert includes an ID of the device, and an incident time obtained from the time measurer.

The system of any aspect of the first aspect of the invention may be one wherein the device configured to sense and to transmit sensory data is a security seal sensor device of any aspect of the fifth aspect of the invention.

According to a sixth aspect of the invention, there is provided a car (e.g. insurance) sensor device, the device including a time measurer, the device including sensors, the device attachable to a car, the car (e.g. insurance) sensor making sensory measurements using its sensors, the measurements including: is the car moving Yes or No?, to track the amount of time the car is moving using the time measurer, wherein the device is configured to send the amount of time the car is moving to a server.

The device may be one further including one or more or all of: position sensor e.g. GPS position sensor, temperature sensor, humidity sensor, light intensity sensor, acceleration sensor.

The device may be configured to make sensory measurements using its sensors, the measurements including one or more or all of: position measurement using position sensor e.g. GPS position sensor; temperature measurement using temperature sensor; humidity measurement using humidity sensor; light intensity using light intensity sensor; acceleration, using acceleration sensor, wherein the device is configured to send sensor data to a server.

The device may be one wherein the car (e.g. insurance) sensor device is a sticker-like device.

The device may be one wherein the car (e.g. insurance) sensor device is a solar powered device, the device including a solar cell and a battery arranged to be charged by the solar cell.

The device may be one wherein the car (e.g. insurance) sensor device is configured to determine if a receiver is available for transmitting as-yet not transmitted sensor data to a server, and if one is available then available and/or stored data is sent to the server.

The device may be one wherein the car (e.g. insurance) sensor device is configured to determine if a receiver is available for transmitting as-yet not transmitted sensor data to a server, and if one is not available then the sensory data is stored in memory of the car (e.g. insurance) sensor device.

The device may be one wherein the car (e.g. insurance) sensor device includes a solar panel, a sticky part (e.g. for affixing to a windscreen), a PCB including sensors, a battery, and a body.

The system of any aspect of the first aspect of the invention may be one wherein the device configured to sense and to transmit sensory data is a car (e.g. insurance) sensor device of any aspect of the sixth aspect of the invention.

According to a seventh aspect of the invention, there is provided a power meter sensor device, the device including a cable ring and a transformer, the device arranged to measure current and voltage in a (e.g. single) wire, the device further arranged to calculate consumed power, wherein the device is further arranged to calculate the amount of power consumed.

The power meter sensor device may be arranged to make sensory measurements using its sensors, the measurements including: current measurements, and/or voltage measurements.

The power meter sensor device may be one wherein the power meter sensor device is configured to determine if a receiver is available for transmitting as-yet not transmitted sensor data, or data derived from sensor data, to a server, and if one is available then available and/or stored data is sent to the server.

The power meter sensor device may be one wherein the power meter sensor device is configured to determine if a receiver is available for transmitting as-yet not transmitted sensor data to a server, and if one is not available then the sensory data, or data derived from sensor data, is stored in memory of the power meter sensor device.

The power meter sensor device may be one including a processor, wherein the device is arranged to send a customizable alert, if an alert condition is satisfied.

The system of any aspect of the first aspect of the invention may be one wherein the device configured to sense and to transmit sensory data is a power meter sensor device of any aspect of the seventh aspect of the invention.

According to an eighth aspect of the invention, there is provided a people counter sensor device, the device including a passive infrared (PIR)-sensor and a battery, the device arranged to count a number of people who have been present in a vicinity of the sensor device, wherein the people counter sensor device is configured to determine if a user alert is necessary, based on the measured people count and battery level, and if the people counter sensor determines a user alert is necessary, based on the measured people count and battery level, then a user alert is sent.

The sensor device may be one including a Fresnel Lens or time of flight (TOF) sensor, arranged to count a number of people who have been present in a vicinity of the sensor device.

The sensor device may be one wherein the device can be easily mounted to different objects without the necessity to supply any power.

The sensor device may be one wherein the sensor device is configured to determine if a receiver is available for transmitting as-yet not transmitted sensor data, or data derived from sensor data, to a server, and if one is available then available and/or stored data is sent to the server.

The sensor device may be one wherein the sensor device is configured to determine if a receiver is available for transmitting as-yet not transmitted sensor data to a server, and if one is not available then the sensory data, or data derived from sensor data, is stored in memory of the people counter sensor device.

The system of any aspect of the first aspect of the invention may be one wherein the device configured to sense and to transmit sensory data is a people counter sensor device of any aspect of the eighth aspect of the invention.

According to a ninth aspect of the invention, there is provided a waste bin sensor device, the device including an ultrasonic generator and an ultrasonic sensor, the device attachable to an inside of a waste bin, the device arranged to track an amount of free space left in a waste bin and to trigger an alert when the available space in the waste bin falls below a predetermined amount.

The sensor device may be arranged to trigger an alert when the waste bin is almost full.

The sensor device may be one wherein the waste bin sensor device makes sensory measurements using its sensors, the measurements including a position measurement using a position sensor e.g. GPS position sensor.

The sensor device may be one wherein the waste bin sensor device makes sensory measurements using its sensors, the measurements including one or more of, or all of: temperature measurement using temperature sensor; humidity measurement using humidity sensor; light intensity using light intensity sensor.

The sensor device may be one wherein the waste bin sensor device determines if any measured data requires that a user alert be sent, and if any measured data requires that a user alert be sent, then a user alert is sent.

The system of any aspect of the first aspect of the invention may be one wherein the device configured to sense and to transmit sensory data is a waste bin sensor device of any aspect of the ninth aspect of the invention.

According to a tenth aspect of the invention, there is provided a box sensor device, the device attachable to a box, the device including a temperature sensor, a light sensor or sensors, an acceleration sensor and a humidity sensor, the device configured to make sensory measurements using its sensors, the measurements including a temperature measurement using the temperature sensor, a light intensity measurement using the light intensity sensor, an acceleration measurement using the acceleration sensor, and a humidity measurement using humidity sensor, wherein the device is configured to send sensor data to a server.

The sensor device may be one further including: a picked-up sensor to detect that the box has been picked up.

The sensor device may be one further including: a position sensor e.g. GPS position sensor.

The sensor device may be one wherein the device is configured to make sensory measurements using its sensors, the measurements including: position measurement using position sensor e.g. GPS position sensor, and/or a picked-up measurement using the picked-up sensor, wherein the device is configured to send sensor data to a server.

The sensor device may be one wherein the box sensor device is a sticker-like device.

The sensor device may be one wherein the box sensor device is configured to determine if a receiver is available for transmitting as-yet not transmitted sensor data to a server, and if one is available then available and/or stored data is sent to the server.

The sensor device may be one wherein the box sensor device is configured to determine if a receiver is available for transmitting as-yet not transmitted sensor data to a server, and if one is not available then the sensory data is stored in memory of the box sensor device.

The sensor device may be one wherein the box includes a condition-sensitive filling.

The system of any aspect of the first aspect of the invention may be one wherein the device configured to sense and to transmit sensory data is a box sensor device of any aspect of the tenth aspect of the invention.

According to an eleventh aspect of the invention, there is provided a window sensor device, the device including sensors, the device integratable into a window, the window sensor device making sensory measurements using its sensors, the measurements including temperature measurement using a temperature sensor; humidity measurement using a humidity sensor, and window state (e.g. window open, window closed) using window open sensor, wherein the device is configured to send sensor data to a server.

The device may be configured to count the number of openings and closings of a window.

The device may be one further including one or more or all of: position sensor e.g. GPS position sensor, temperature sensor, humidity sensor, light intensity sensor, acceleration sensor.

The device may be one wherein the device is a solar powered device, the device including a solar cell and a battery arranged to be charged by the solar cell.

The device may be one wherein the device is further configured to make sensory measurements using its sensors, the measurements including one or more or all of: position measurement using position sensor e.g. GPS position sensor; light intensity using light intensity sensor; acceleration, using acceleration sensor, wherein the device is configured to send sensor data to a server.

The system of any aspect of the first aspect of the invention may be one wherein the device configured to sense and to transmit sensory data is a window sensor device of any aspect of the eleventh aspect of the invention.

According to a twelfth aspect of the invention, there is provided a smart city sensor device, for measuring environmental conditions in a city, the device including a microphone, an accelerometer and a thermometer, the device arranged to measure noise level using the microphone, the device arranged to measure vibration using the accelerometer, and the device arranged to measure temperature using the thermometer.

The smart city sensor device may be one wherein the device is attachable to city infrastructure objects (e.g. lampposts, traffic lights, road signs).

The smart city sensor device may be one wherein the device is a solar powered device, the device including a solar cell and a battery arranged to be charged by the solar cell.

The smart city sensor device may be one configured to make sensory measurements using its sensors, the measurements including: humidity measurement using humidity sensor, and/or light intensity using light intensity sensor.

The smart city sensor device may be one wherein the smart city sensor device is a sticker-like device.

The smart city sensor device may be one wherein the smart city sensor device has a thickness in the range of 2 mm to 5 mm, preferably 4 mm.

The smart city sensor device may be rain water resistant.

The smart city sensor device may be one configured to determine if a receiver is available for transmitting as-yet not transmitted sensor data to a server, and if one is available then available and/or stored data is sent to the server.

The smart city sensor device may be one configured to determine if a receiver is available for transmitting as-yet not transmitted sensor data to a server, and if one is not available then the sensory data is stored in memory of the smart city sensor device.

The system of any aspect of the first aspect of the invention may be one wherein the device configured to sense and to transmit sensory data is a smart city sensor device of any aspect of the twelfth aspect of the invention.

According to a thirteenth aspect of the invention, there is provided a toothpaste tube sensor device, the toothpaste tube sensor device configured to make sensory measurements using its sensors, the measurements including: measuring toothpaste amount left.

The toothpaste tube sensor device may be configured to determine if a receiver is available for transmitting as-yet not transmitted sensor data to a server, and if one is available then available and/or stored data is sent to the server.

The toothpaste tube sensor device may be configured to determine if a receiver is available for transmitting as-yet not transmitted sensor data to a server, and if one is not available then the sensory data is stored in memory of the toothpaste tube sensor device.

The system of any aspect of the first aspect of the invention may be one wherein the device configured to sense and to transmit sensory data is a toothpaste tube sensor device of any aspect of the thirteenth aspect of the invention.

According to a fourteenth aspect of the invention, there is provided a mouthwasher sensor device, the mouthwasher sensor device configured to make sensory measurements using its sensors, the measurements including: measuring mouthwasher liquid amount left in a container (e.g. in a tube).

The mouthwasher sensor device may include a bottle cap, including an ultrasonic generator and an ultrasonic sensor.

The mouthwasher sensor device may be one wherein the mouthwasher sensor device is a pressure sensor which is usable at the bottom of a container (e.g. a bottle).

The mouthwasher sensor device may be one wherein the mouthwasher sensor device is configured to make sensory measurements using its sensors, the measurements including: measuring liquid amount left, e.g. measuring liquid level.

The mouthwasher sensor device may be one wherein the mouthwasher sensor device is configured to determine if a receiver is available for transmitting as-yet not transmitted sensor data to a server, and if one is available then available and/or stored data is sent to the server.

The mouthwasher sensor device may be one wherein the mouthwasher sensor device is configured to determine if a receiver is available for transmitting as-yet not transmitted sensor data to a server, and if one is not available then the sensory data is stored in memory of the mouthwasher sensor device.

The system of any aspect of the first aspect of the invention may be one wherein the device configured to sense and to transmit sensory data is a mouthwasher sensor device of any aspect of the fourteenth aspect of the invention.

According to a fifteenth aspect of the invention, there is provided a revolution sensor device, the device attachable to a rotatable object, the device including an accelerometer, the device configured to use the accelerometer for counting rotations of the rotatable object.

The revolution sensor device may be one wherein the revolution sensor device is configured as a tube, or wherein the revolution sensor device is attached to a tube.

The revolution sensor device may be one wherein the revolution sensor is configured to make sensory measurements using its sensors, the measurements including: measuring acceleration using the accelerometer.

The revolution sensor device may be one wherein if a revolution is detected, then a count of the revolution is recorded.

The revolution sensor device may be one wherein the revolution sensor is configured to count the amount of material left in a single roll.

The revolution sensor device may be one wherein the revolution sensor device is configured to determine if a receiver is available for transmitting as-yet not transmitted sensor data to a server, and if one is available then available and/or stored data is sent to the server.

The revolution sensor device may be one wherein the revolution sensor device is configured to determine if a receiver is available for transmitting as-yet not transmitted sensor data to a server, and if one is not available then the sensory data is stored in memory of the revolution sensor device.

The system of any aspect of the first aspect of the invention may be one wherein the device configured to sense and to transmit sensory data is a revolution sensor device of any aspect of the fifteenth aspect of the invention.

According to a sixteenth aspect of the invention, there is provided a paper dispenser sensor device, the device attachable to a paper towel dispenser, the device configured to measure the amount (e.g. the number) of paper towels left in the paper towel dispenser.

The paper dispenser sensor device may be one including an infra red (IR) source and detector, arranged to detect a height of a stack of paper.

The paper dispenser sensor device may be one including an ultrasonic generator and an ultrasonic detector, arranged to measure the amount (e.g. the number) of paper towels left in the paper towel dispenser.

The paper dispenser sensor device may be one wherein the paper dispenser sensor device determines if the dispenser is low or empty.

The paper dispenser sensor device may be one wherein if the paper dispenser sensor determines the dispenser is low or empty, the paper dispenser sensor device sends an alert to maintenance.

The system of any aspect of the first aspect of the invention may be one wherein the device configured to sense and to transmit sensory data is a paper dispenser sensor device of any aspect of the sixteenth aspect of the invention.

According to a seventeenth aspect of the invention, there is provided a medical storage sensor device, the device including a position sensor (e.g. GPS position sensor), a temperature sensor and a humidity sensor, the device including a water-resistant casing.

The device may be one wherein the water resistant casing is an IP67 casing.

The device may be one wherein the medical storage sensor device includes customizable alerts.

The device may be one wherein the medical storage sensor makes sensory measurements using its sensors, the measurements including: position measurement using the position sensor (e.g. GPS position sensor); temperature measurement using the temperature sensor; humidity measurement using the humidity sensor.

The device may be one wherein medical storage sensor determines if the sensor data requires a user alert to be sent.

The device may be one wherein if the medical storage sensor determines that the sensor data requires a user alert to be sent, then a user alert is sent.

The device may be one wherein the medical storage sensor device is configured to determine if a receiver is available for transmitting as-yet not transmitted sensor data to a server, and if one is available then available and/or stored data is sent to the server.

The device may be one wherein the medical storage sensor device is configured to determine if a receiver is available for transmitting as-yet not transmitted sensor data to a server, and if one is not available then the sensory data is stored in memory of the medical storage sensor device.

The system of any aspect of the first aspect of the invention may be one wherein the device configured to sense and to transmit sensory data is a medical storage sensor device of any aspect of the seventeenth aspect of the invention.

According to an eighteenth aspect of the invention, there is provided a laser tachometer sensor device, the device including a laser and a light sensor arranged to detect reflected or scattered laser light, the laser tachometer sensor configured to make sensory measurements using its sensors, the measurements including: measuring revolutions per minute (rpm).

The device may be one wherein the device determines using the measured rpm data if a user alert needs to be generated, and if the device determines using the measured rpm data that a user alert needs to be generated, then a user alert is sent.

The device may be one wherein the device measures the rpm of a spinning tool.

The device may be one wherein the device has customizable alerts for use if the tool's revolutions per minute (rpm) goes beyond predefined limits.

The device may be one wherein the device doesn't require any physical contact with a working tool.

The device may be one wherein the device is placed in a line of sight of a working spinning tool.

The system of any aspect of the first aspect of the invention may be one wherein the device configured to sense and to transmit sensory data is a laser tachometer sensor device of any aspect of the eighteenth aspect of the invention.

According to an nineteenth aspect of the invention, there is provided a flow sensor device, the device including a flow speed sensor, a vibration sensor, a pump power sensor, and a temperature sensor, wherein the flow sensor is configured to makes sensory measurements using its sensors, the measurements including: measuring flow temperature using the temperature sensor; measuring flow speed using the flow speed sensor; measuring vibrations using the vibration sensor; measuring pump power using the power sensor.

The device may be one wherein the flow sensor device is attachable to an industrial pipe.

The device may be one wherein the device is configurable to generate customizable alerts.

The device may be one wherein the sensor device determines using the measured data if a user alert needs to be generated, and if the sensor device determines using the measured data that a user alert needs to be generated, then a user alert is sent.

The system of any aspect of the first aspect of the invention may be one wherein the device configured to sense and to transmit sensory data is a flow sensor device of any aspect of the nineteenth aspect of the invention.

According to a twentieth aspect of the invention, there is provided a log sensor device, the device including a speaker and a microphone which, in use, are placed respectively on the log's two ends, wherein the microphone is arranged to detect sound emitted by the speaker which is transmitted by the log, and detected sound data is generated by the microphone, and the microphone is configured to process the detected sound data to determine the integrity of the log.

The log sensor device may be one wherein the sensor device determines, using the measured data, if a user alert needs to be generated, and if the sensor device determines using the measured data that a user alert needs to be generated, then a user alert is sent.

The log sensor device may be one wherein the log sensor device determines if a receiver is available for transmitting as-yet not transmitted sensor data to a server.

The log sensor device may be one wherein if no receiver is available, the sensory data is stored in memory of the log sensor device.

The log sensor device may be one wherein if a receiver is available, available and/or stored data is sent to the server.

The log sensor device may be one wherein the speaker and the microphone are in wireless communication with each other.

The log sensor device may be one wherein the speaker and the microphone in wired communication with each other.

The system of any aspect of the first aspect of the invention may be one wherein the device configured to sense and to transmit sensory data is a log sensor device of any aspect of the twentieth aspect of the invention

In further aspects of the invention, respective methods or systems relating to respective aspects of the invention may be provided. Aspects of the invention may be combined.

### BRIEF DESCRIPTION OF THE FIGURES

Aspects of the invention will now be described, by way of example(s), with reference to the following Figures, in which:

FIG. 1A shows on the right an example of a device configured to sense and to transmit sensory data, and on the left, an enlarged example of a printed circuit board (PCB) of the device configured to sense and to transmit sensory data.

FIG. 1B shows on the right an example of a device configured to sense and to transmit sensory data, and on the left, an enlarged example of a printed circuit board (PCB) of the device configured to sense and to transmit sensory data.

FIG. 2 shows an example system including sensors, gateways, and a Master Node.

FIG. 3 shows data from a tracking system, in which the products are tracked through the stages of production, being stored, being sold, being used, and then being recycled.

FIG. 4 shows an example of a method of operation of a logistic sensor.

FIG. 5 shows an example of a bottle cap, the cap including a screw cap, a PCB including sensors, a battery, a pad and a lower seal, in an exploded view.

FIG. 6 shows an example of a method of operation of a pipe sensor.

FIG. 7A shows an example of a method of operation of a security seal sensor.

FIG. 7B shows an example of a security seal, situated on taping of a box.

FIG. 8 shows an example of a method of operation of a car insurance sensor.

FIG. 9 shows an example of a car insurance sensor, in an exploded view.

FIG. 10 shows an example of a method of operation of a power meter sensor.

FIG. 11A shows an example of a method of operation of a people counter sensor.

FIG. 11B shows an example of a people counter sensor device, the device including a people counter sensor.

FIG. 12 shows an example of a method of operation of a waste bin sensor.

FIG. 13A shows an example of a method of operation of a box sensor.

FIG. 13B shows an exploded view of an example of a box sensor, in which the box sensor includes a PCB and a battery within the box sensor interior.

FIG. 14 shows an example of a method of operation of a window sensor.

FIG. 15A shows an example of a method of operation of a smart city sensor.

FIG. 15B shows an example of a smart city sensor.

FIG. 16 shows an example of a method of operation of a toothpaste tube sensor.

FIG. 17 shows an example of a method of operation of a mouthwasher sensor.

FIG. 18 shows an example of a method of operation of a revolution sensor.

FIG. 19A shows an example of a method of operation of a paper dispenser sensor.

FIG. 19B shows an example of a paper dispenser, the paper dispenser including an infra red (IR) source and detector, arranged to detect a height of a stack of paper.

FIG. 20 shows an example of a method of operation of a medical storage sensor.

FIG. 21 shows an example of a method of operation of a laser tachometer sensor.

FIG. 22 shows an example of a method of operation of a flow sensor.

FIG. 23A shows an example of a method of operation of a log sensor.

FIG. 23B shows an example of a log sensor device including a speaker and a microphone, the speaker and the microphone in wireless communication with each other; the speaker is attached to one end of a log and emits sound into the log; the microphone is attached to the opposite end of the log to the speaker.

FIG. 23C shows an example of a highly defective portion of a log.

### DETAILED DESCRIPTION

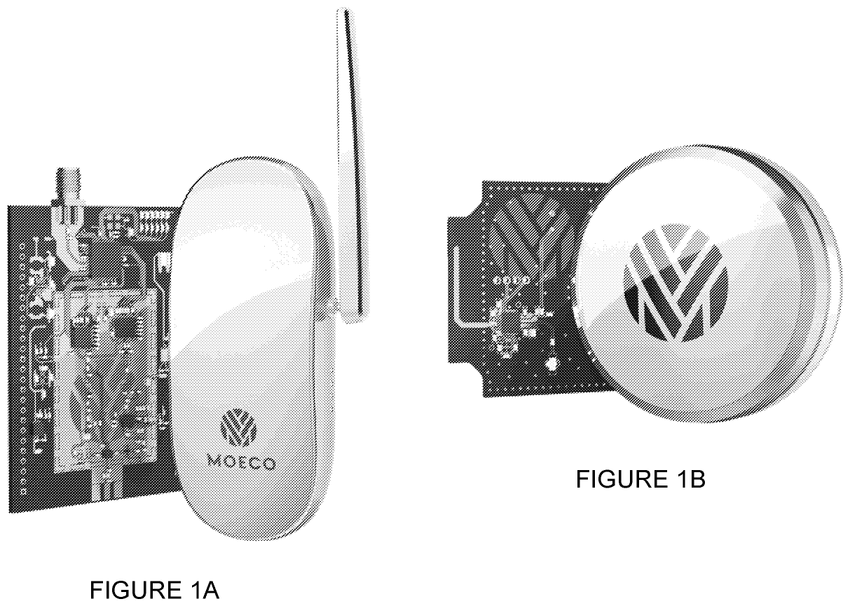

Devices configured to sense and to transmit sensory data (e.g. Moeco devices) can operate with any one, or more, or all, of the following technologies for data transfer: WiFi, Bluetooth, low-power wide-area network (LPWAN) or Global System for Mobile Communications (GSM)/Narrowband Internet of Things (NB-IoT), after collecting data. Data is generated by different physical sensors in the devices, wherein the devices are configured to sense and to transmit sensory data, and the transmitted data is aggregated by gateways, wherein the gateways then transfer data into a Master Node (e.g. Moeco Master Node). The Master Node (e.g. Moeco Masternode) receives data from the Gateways e.g. through the Middleware; the Master Node provides necessary access to collected data. Data can be used by applications external to the Master Node through application programming interface (API) interfaces (e.g. Moeco API interfaces). FIG. 1A shows on the right an example of a device configured to sense and to transmit sensory data, and on the left, an enlarged example of a printed circuit board (PCB) of the device configured to sense and to transmit sensory data. FIG. 1B shows on the right an example of a device configured to sense and to transmit sensory data, and on the left, an enlarged example of a printed circuit board (PCB) of the device configured to sense and to transmit sensory data.

A device configured to sense and to transmit sensory data typically includes a battery. A device configured to sense and to transmit sensory data typically includes a processor.

A device configured to sense and to transmit sensory data, the device including a Bluetooth interface, may send data using the Bluetooth interface to Bluetooth gateways, or to smartphones where the smartphones are programmed with an application (e.g. Moeco App or another App with a software development kit (SDK) e.g. a Moeco SDK). These smartphones programmed with an application may become gateways and they may send sensory data (e.g. further sensory data) to infrastructure (e.g. Moeco infrastructure). Devices configured to sense and to transmit sensory data may support both connectable and non-connectable modes of data transfer.

Devices configured to sense and to transmit sensory data (e.g. Moeco devices) may be configured with LoRa (Long Range) technology, and may send data to LPWAN gateways, and then the data may be transferred to an LPWAN server which is connected to a Master Node (e.g. Moeco Master Node).

Devices configured to sense and to transmit sensory data, the devices supporting WiFi communications, may send data via a regular WiFi router to the cloud or using premises-based software gateways that forward the data to a Master Node (e.g. Moeco Master Node).

Devices configured to sense and to transmit sensory data, the devices supporting GSM and/or Narrow Band communications, may send data to a mobile operator's cloud which is also connected to a Master Node (e.g. Moeco Master Node).

A device configured to sense and to transmit sensory data may be a portable device. A device configured to sense and to transmit sensory data may be a handheld device. A device configured to sense and to transmit sensory data may include a touch screen.

In an example system, sensor devices collect sensor data (e.g. temperature, location or acceleration data), and transmit the collected data to gateways, e.g. via one or more of WiFi, Bluetooth, LPWAN or GSM/NB-IoT communications. Communications may include wireless communications or wired communications. The gateways may transmit the received collected data to a gateway API, which may store the received data using a blockchain system (e.g. Moeco EOS blockchain) using a synchronization server, where the data may then be stored as a structured query language (SQL) database (DB) on a server (e.g. a Moeco App Server). The gateway API, the blockchain system, the synchronization server, the structured query language (SQL) database (DB) and the server storing the SQL DB may all be present at a Master Node (e.g. Moeco Master Node).

The Master Node may perform integrations to payments gateways (e.g. PayPal, VISA).

The Master Node may include APIs eg. to a cloud system, to a custom system, or to provide data views. The APIs eg. to a cloud system, to a custom system, or to provide data views, may connect to 3^{rd} side data analysis engines, or to stand alone solutions.

The Master Node may provide a WEB view in connection with a web application (e.g. Moeco Web App).

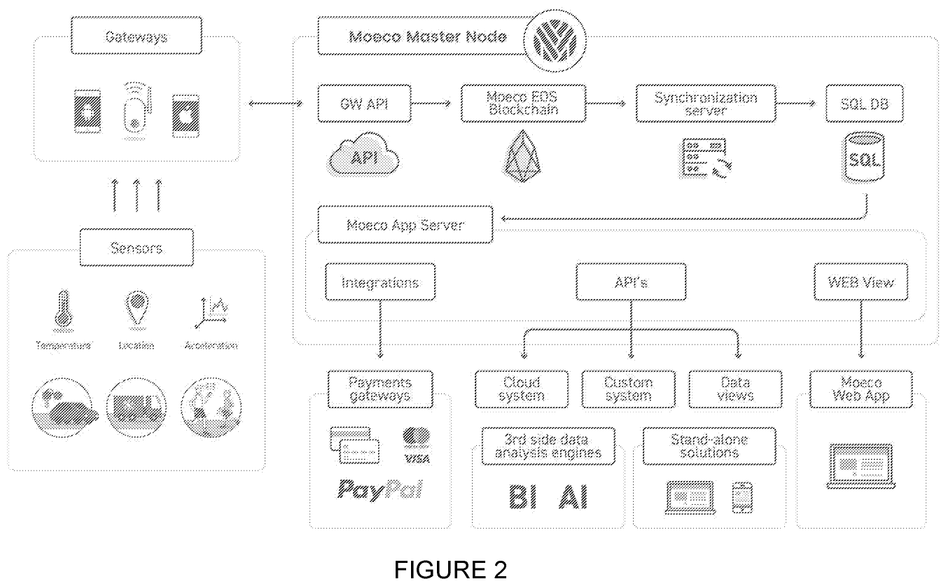

An example system including sensors, gateways, and a Master Node, is shown in FIG. 2.

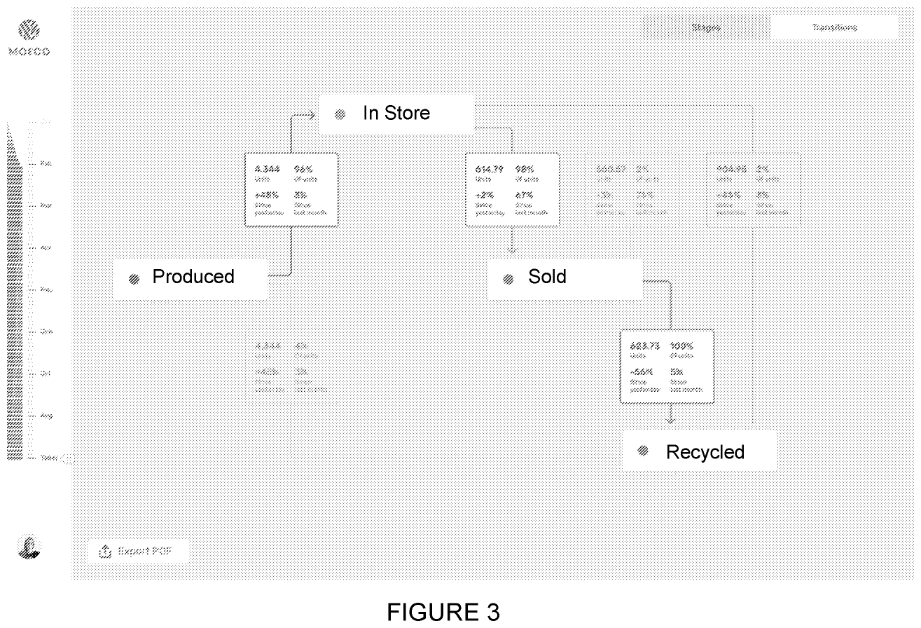

During data processing, a platform (eg. a Moeco platform) can recognize a life cycle stage of the sensor which sent the data. These life cycle stages can be customized in a server (e.g. a Moeco server), hence it's possible to build, or to track, a full life cycle of a product: e.g. from production to storing, selling, using and then to recycling, of the product. An example is shown in FIG. 3, which shows data from a tracking system, in which the products are tracked through the stages of production, being stored, being sold, being used, and then being recycled.

In an example, a device configured to sense and to transmit sensory data is produced (e.g. at a factory) and powered-up. After power-up, the device communicates with a local gateway, and provides a unique device ID in a communication via the gateway; the device may communicate a location. The gateway sends the transmission to the Master Node, wherein the transmission may identify the gateway. At the Master Node, this newly produced device is identified using its unique device ID, and a record is created, or is updated, for tracking this newly produced device through its life cycle. The identity of the gateway may be used to establish, or to confirm, that the device is newly produced. The communicated location may be used to establish, or to confirm, that the device is newly produced. For example, if the communication identifies the gateway, and the Master Node includes, or has access to, a database which identifies gateways associated with device-producing locations (e.g. device manufacturing locations), then the identity of the gateway may be used to establish, or to confirm, that the device is indeed newly-produced, or newly manufactured. For example, if a communicated location is provided, and the Master Node includes, or has access to, a database which identifies locations associated with device-producing locations (e.g. device manufacturing locations), then the communicated location may be used to establish, or to confirm, that the device is indeed newly-produced, or newly manufactured. The device may be configured (e.g. programmed) to communicate that it is newly-produced, or newly manufactured.

In an example, a device configured to sense and to transmit sensory data is moved after it has been produced (e.g. at a factory), to a place where it is stored, or to a place from which it is sold. At the place of storage, or of sale, the device communicates with a local gateway, and provides its unique device ID in a communication via the gateway; the device may communicate a location. The gateway sends the transmission to the Master Node, wherein the transmission may identify the gateway. At the Master Node, this device is identified using its unique device ID, and its previously created record for tracking this device through its life cycle is updated. The identity of the gateway may be used to establish, or to confirm, that the device is at a place of storage, or at a place of sale. The communicated location may be used to establish, or to confirm, that the device is at a place of storage, or at a place of sale. For example, if the communication identifies the gateway, and the Master Node includes, or has access to, a database which identifies gateways associated with device-storing locations (e.g. warehouses), or with device-selling locations (e.g. retail locations) then the identity of the gateway may be used to establish, or to confirm, that the device is indeed being stored, or is being put on sale. For example, if a communicated location is provided, and the Master Node includes, or has access to, a database which identifies locations associated with device-storing locations (e.g. warehouses), or with device-selling locations (e.g. retail locations), then the communicated location may be used to establish, or to confirm, that the device is indeed being stored, or is being put on sale. The device may be configured (e.g. programmed) to communicate that it is being stored, or is being put on sale.

In an example, a device configured to sense and to transmit sensory data is moved after it has been stored or sold, to a place where it is used. During or after some usage, the device communicates with a local gateway, and provides its unique device ID in a communication via the gateway. The gateway sends the transmission to the Master Node, wherein the transmission may identify the gateway; the device may communicate a location. At the Master Node, this device is identified using its unique device ID, and its previously created record for tracking this device through its life cycle is updated. The identity of the gateway may be used to establish, or to confirm, that the device is no longer at a place of storage, or at a place of sale, or at a place of manufacture, and hence it is now being used, and hence the record for tracking this device is updated to reflect that it is being used. The communicated location may be used to establish, or to confirm, that the device is no longer at a place of storage, or at a place of sale, or at a place of manufacture, and hence it is now being used, and hence the record for tracking this device is updated to reflect that it is being used. For example, if the communication identifies the gateway, and the Master Node includes, or has access to, a database which identifies gateways associated with device-storing locations (e.g. warehouses), or with device-selling locations (e.g. retail locations), or with device producing locations, then the identity of the gateway may be used to establish, or to confirm, that the device is indeed being used, because it is not at a place of storage, it is not at a place where it is on sale, and it is no longer at a place of manufacture. For example, if a communicated location is provided, and the Master Node includes, or has access to, a database which identifies locations associated with device-storing locations (e.g. warehouses), or with device-selling locations (e.g. retail locations), or with device producing locations, then the communicated location may be used to establish, or to confirm, that the device is indeed being used, because it is not at a place of storage, it is not at a place where it is on sale, and it is no longer at a place of manufacture. The device may be configured (e.g. programmed) to communicate that it is being used.

In an example, a device configured to sense and to transmit sensory data is moved after it has been used, to a place where it can be recycled or decommissioned. At the recycling or decommissioning location, the device communicates with a local gateway, and provides its unique device ID in a communication via the gateway. The gateway sends the transmission to the Master Node, wherein the transmission may identify the gateway; the device may communicate a location. At the Master Node, this device is identified using its unique device ID, and its previously created record for tracking this device through its life cycle is updated. The identity of the gateway may be used to establish, or to confirm, that the device is at a recycling location or at a decommissioning location, and hence it is now being recycled or decommissioned, and hence the record for tracking this device is updated to reflect that it is being recycled or decommissioned. The communicated location may be used to establish, or to confirm, that the device is at a recycling location or at a decommissioning location, and hence it is now being recycled or decommissioned, and hence the record for tracking this device is updated to reflect that it is being recycled or decommissioned. For example, if the communication identifies the gateway, and the Master Node includes, or has access to, a database which identifies locations associated with recycling or decommissioning, then the identity of the gateway may be used to establish, or to confirm, that the device is indeed being recycled or decommissioned. For example, if a communicated location is provided, and the Master Node includes, or has access to, a database which identifies locations associated with recycling or decommissioning, then the communicated location may be used to establish, or to confirm, that the device is indeed being recycled or decommissioned. The device may be configured (e.g. programmed) to communicate that it is being recycled or decommissioned.

A user interface may be provided (e.g. through a Web App (e.g. Moeco Web App)) in which data is displayed relating to tracking the life cycle of a product, e.g. from production to storing, selling, using and then to recycling, of the product. An example is shown in FIG. 3. The displayed data may be received from a Master Node (e.g. Moeco Master Node).

The following example devices may be devices for which the life cycle of the product is tracked, using a tracking system, such as described above, and the devices may be configured for use with such a tracking system.

### Example Devices

1) Logistic Sensor (e.g. Moeco Logistic Sensor)

In an example, a logistic sensor is used to collect data about the current location and storage/transportation conditions of e.g. a parcel or package to which it is attached. The logistic sensor may be a sticker-like device. The logistic sensor may include one or more, or all, of: a temperature sensor, a light sensor or sensors, an accelerometer. The logistic sensor can be enhanced by a secure seal for detecting heavy damage or opening of a parcel or package to which it is attached. The logistic sensor may include customizable alarms that depend on the logistic sensor's current condition.

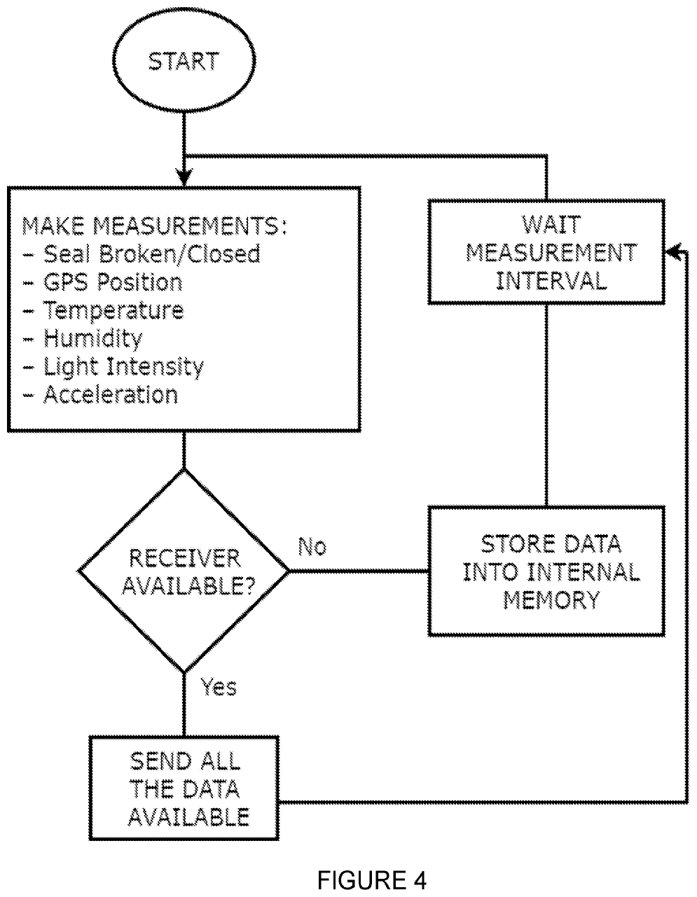

In an example operation of a logistic sensor, the logistic sensor makes sensory measurements using its sensors, the measurements including one or more of, or all of: is the Seal broken or closed?; position measurement using position sensor e.g. GPS position sensor; temperature measurement using temperature sensor; humidity measurement using humidity sensor; light intensity using light intensity sensor; acceleration, using acceleration sensor. The logistic sensor determines if a receiver is available for transmitting as-yet not transmitted sensor data to a server. If no receiver is available, the sensory data is stored in memory of the logistic sensor. The logistic sensor then waits for an interval, before making measurements again. If a receiver is available, available and/or stored data is sent to the server. The logistic sensor then waits for an interval, before making measurements again. FIG. 4 shows an example of a method of operation of a logistic sensor.

2) Test Package-Bottle Cap (e.g. Moeco Plastic Bottle Cap)

In an example, a bottle cap (e.g. Moeco bottle cap) combines a standard plastic bottle cap and a PCB with sensors onboard, which logs data about its storage conditions and whole life cycle. The main goal of this device is to help manufacturers of liquid products to collect physical data from specific bottles and to aggregate the collected data for further analysis.

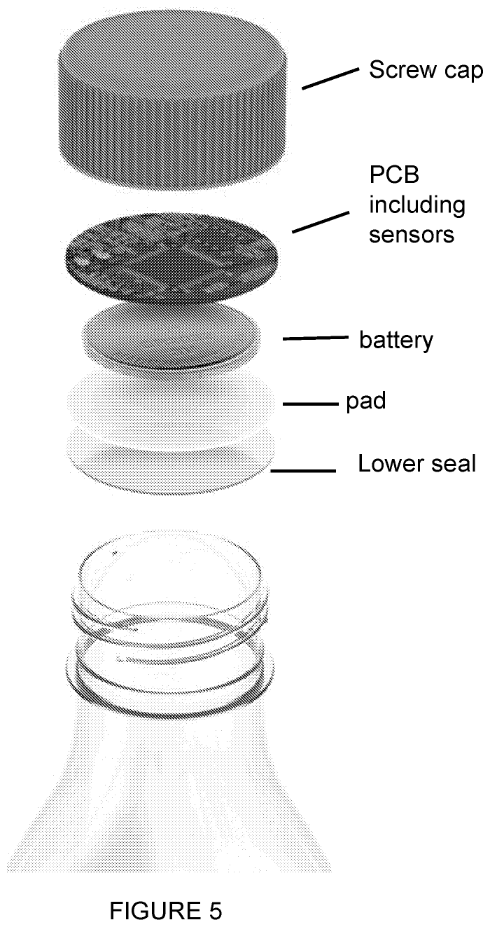

The bottle cap (e.g. Moeco bottle cap) includes sensors which can collect data about one or more, or all of: external temperature, humidity, light brightness, detect movement and openings/closings of the cap. In an example of a bottle cap, the bottle cap includes a bottle cap housing (e.g. a screw cap), a PCB including sensors, a battery, and a lower seal. FIG. 5 shows an example of a bottle cap, the cap including a screw cap, a PCB including sensors, a battery, a pad and a lower seal, in an exploded view.

3) Pipe Sensor (e.g. Moeco Pipe Sensor)

In an example, a pipe sensor (e.g. Moeco pipe sensor) is a device which collects data about the pipe temperature and vibrations which helps to find failure in a tube system. The pipe sensor is fixed on a pipe external surface and doesn't require pipe dismantling. The pipe sensor can sense a pipe's damage, without pipe dismantling.

In an example operation of a pipe sensor, the pipe sensor makes sensory measurements using its sensors, the measurements including one or more of, or all of: temperature measurement using temperature sensor; vibration measurement using vibration sensor.

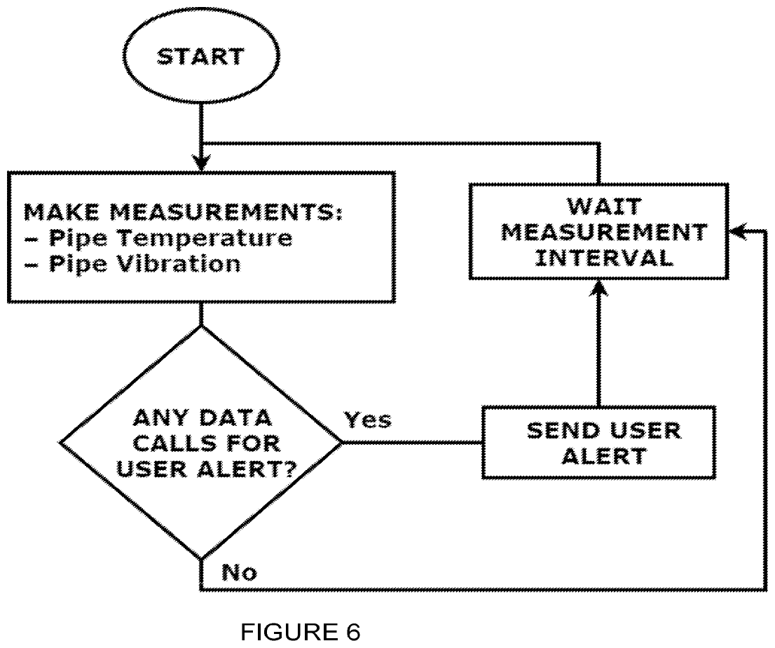

The pipe sensor determines if measured data is such that it may indicate pipe damage, and therefore a user alert needs to be sent. If measured data is such that a user alert needs to be sent, then a user alert is sent. The pipe sensor then waits for an interval, before making measurements again. FIG. 6 shows an example of a method of operation of a pipe sensor.

4) Security Seal Sensor (e.g. Moeco Security Seal Sensor)

In an example, a security seal sensor (e.g. Moeco security seal sensor) is a device which guarantees that a specific container or pallet wasn't illegally opened up and alerts if the seal was broken. If the seal was broken, the security seal sensor sends an alert with its ID and an incident (e.g. accident) time.

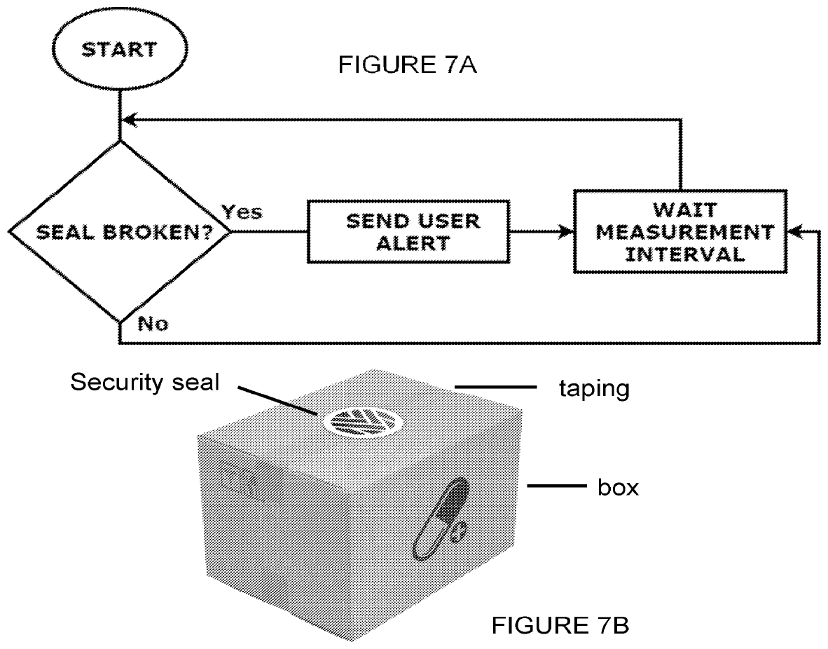

In an example operation of a security seal sensor, the security seal sensor makes sensory measurements using its sensors, the measurements checking if the seal was broken. If measured data is such that the seal is determined to be broken, then a user alert is sent. The security seal sensor then waits for an interval, before making measurements again. FIG. 7A shows an example of a method of operation of a security seal sensor. FIG. 7B shows an example of a security seal, situated on taping of a box. The box may include medical supplies.

5) Car Sensor (e.g. Moeco Car Insurance Sticker Sensor)

In an example, a car insurance sensor (e.g. sticker sensor) (e.g. Moeco car insurance sticker sensor) is a (e.g. solar powered sticker) sensor for a car (e.g. front) window that tracks the amount of time a specific car was moving. In an example, a car insurance sticker sensor is a solar powered sticker for a car front window that tracks the amount of time a specific car was moving. A possible purpose of the sticker includes to provide (e.g. insurance companies with) data about car usage.

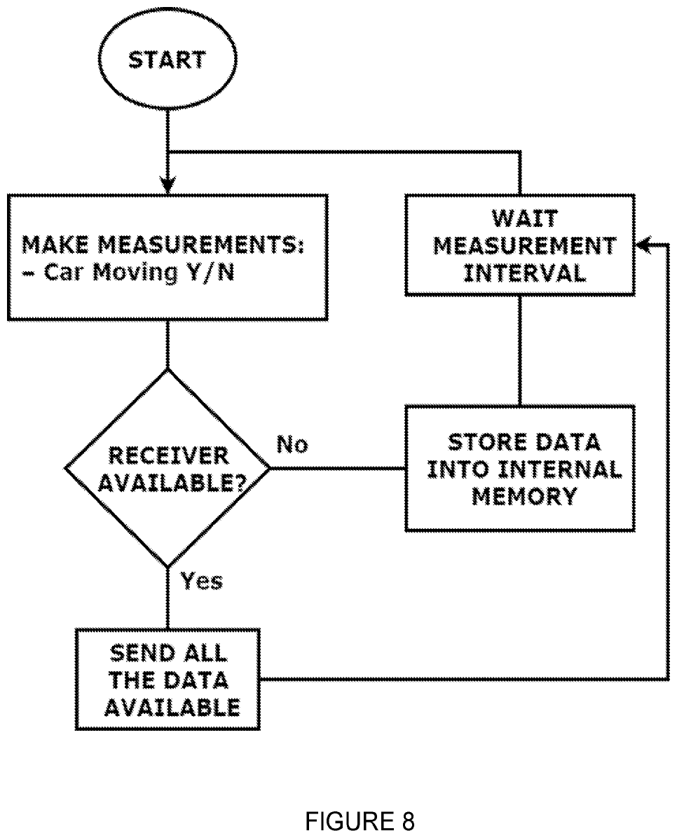

In an example operation of a car insurance sensor, the car insurance sensor makes sensory measurements using its sensors, the measurements including one or more of, or all of: is the car moving Yes or No?; position measurement using position sensor e.g. GPS position sensor; temperature measurement using temperature sensor; humidity measurement using humidity sensor; light intensity using light intensity sensor; acceleration, using acceleration sensor. In an example operation of a car insurance sensor, the car insurance sensor makes sensory measurements using its sensors, the measurements including: is the car moving Yes or No?. The car insurance sensor determines if a receiver is available for transmitting as-yet not transmitted sensor data to a server. If no receiver is available, the sensory data is stored in memory of the car insurance sensor. The car insurance sensor then waits for an interval, before making measurements again. If a receiver is available, available and/or stored data is sent to the server. The car insurance sensor then waits for an interval, before making measurements again. FIG. 8 shows an example of a method of operation of a car insurance sensor.

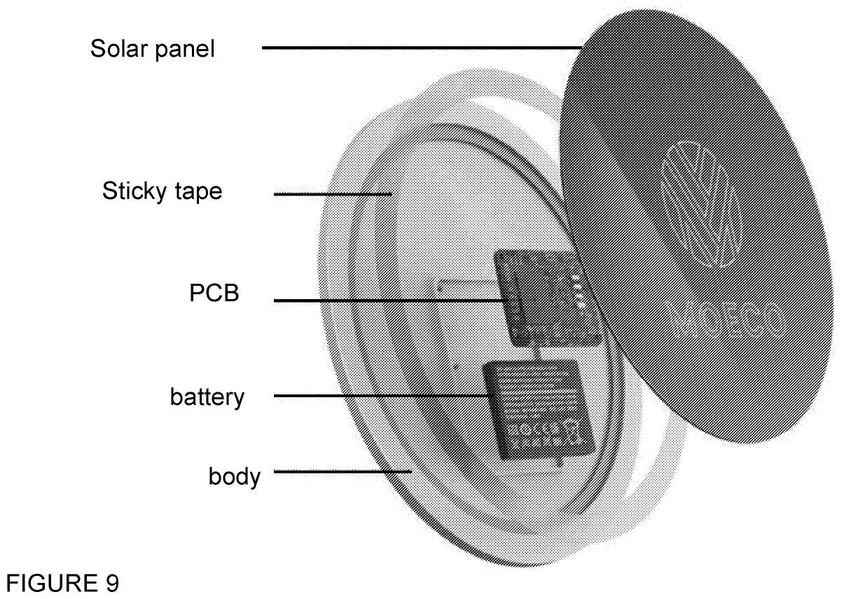

In an example, a car insurance sensor includes a solar panel, a sticky part (e.g. for affixing to a windscreen), a PCB including sensors, a battery, and a body. FIG. 9 shows an example of a car insurance sensor, in an exploded view.

6) Power Meter Sensor (e.g. Moeco Power Meter Sensor)

In an example, a power meter sensor (e.g. Moeco power meter sensor) is a cable ring with a transformer that can measure current and voltage in a single wire, and as well as can calculate consumed power and can count the amount of power consumed, and can do this during a whole operating lifetime. The power meter sensor has customizable alerts which helps automatically to identify a possibly dangerous situation.

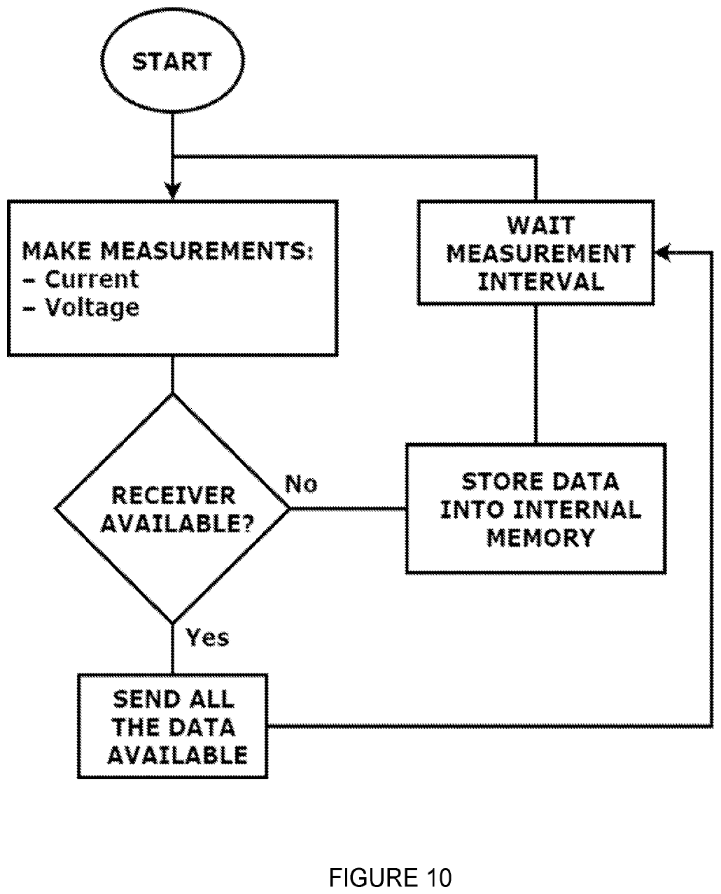

In an example operation of a power meter sensor, the power meter sensor makes sensory measurements using its sensors, the measurements including one or more of, or all of: current measurements, and/or voltage measurements. The power meter sensor determines if a receiver is available for transmitting as-yet not transmitted sensor data to a server. If no receiver is available, the sensory data is stored in memory of the power meter sensor. The power meter sensor then waits for an interval, before making measurements again. If a receiver is available, available and/or stored data is sent to the server. The power meter sensor then waits for an interval, before making measurements again. FIG. 10 shows an example of a method of operation of a power meter sensor.

7) People Counter Sensor (e.g. Moeco People Counter Sensor)

In an example, a people counter sensor (e.g. a Moeco people counter sensor) is a portable passive infrared (PIR)-sensor which may include a Fresnel Lens or time of flight (TOF) sensor based device, and which counts an absolute number of people who have walked one way or another way, as well as the number of people in general. The people counter sensor is battery powered and can be easily mounted to different objects without the necessity to supply any power to this object.

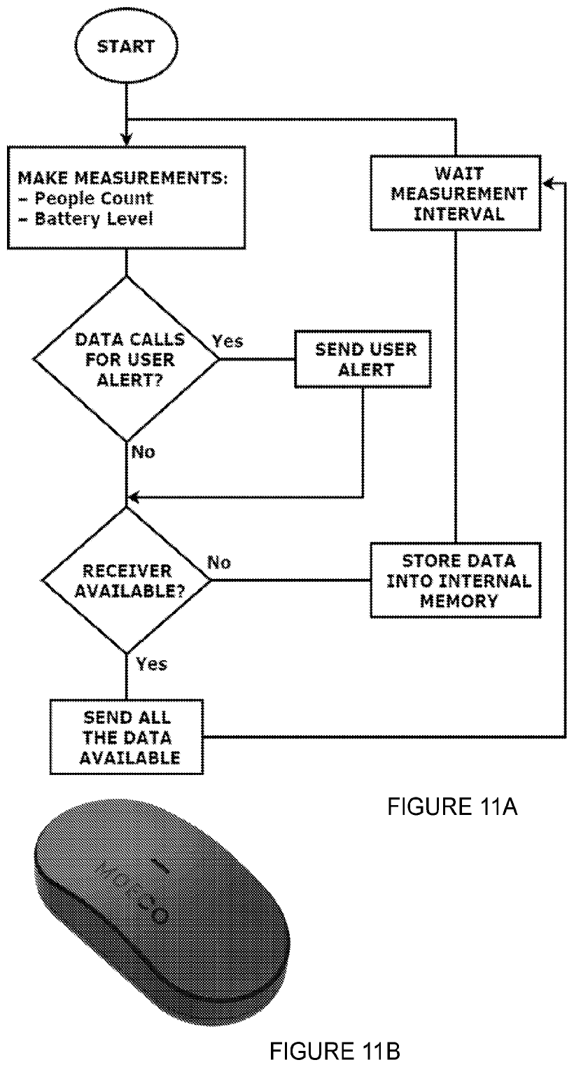

In an example operation of a people counter sensor, the people counter sensor makes sensory measurements using its sensors, the measurements including one or more of, or all of: a people count, and battery level. The people counter sensor determines if a user alert is necessary, based on the measured people count and battery level. If the people counter sensor determines a user alert is necessary, based on the measured people count and battery level, then a user alert is sent. The people counter sensor determines if a receiver is available for transmitting as-yet not transmitted sensor data to a server. If no receiver is available, the sensory data is stored in memory of the people counter sensor. The people counter sensor then waits for an interval, before making measurements again. If a receiver is available, available and/or stored data is sent to the server. The people counter sensor then waits for an interval, before making measurements again. FIG. 11A shows an example of a method of operation of a people counter sensor. FIG. 11B shows an example of a people counter sensor device, the device including a people counter sensor.

8) Waste Bin Sensor (Eg. Moeco Waste Bin Sensor)

In an example, a waste bin sensor (e.g. Moeco waste bin sensor) is an ultrasonic device which tracks the amount of free space left in a waste bin and triggers an alert when the container is almost full. The waste bin sensor may also provide the current location of a waste bin. The waste bin sensor has several versions depending on a waste bin type and generates data useful to reduce waste bin maintenance costs.

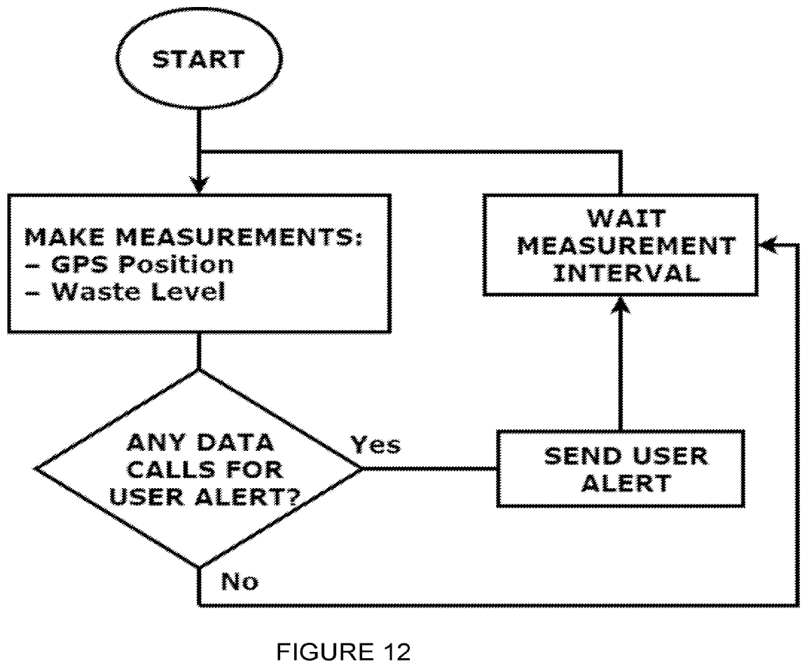

In an example operation of a waste bin sensor, the waste bin sensor makes sensory measurements using its sensors, the measurements including waste level measurement, using an ultrasonic generator and sensor and one or more of, or all of: position measurement using position sensor e.g. GPS position sensor; temperature measurement using temperature sensor; humidity measurement using humidity sensor; light intensity using light intensity sensor. In an example operation of a waste bin sensor, the waste bin sensor makes sensory measurements using its sensors, the measurements including waste level measurement, using an ultrasonic generator and sensor and optionally: position measurement using position sensor e.g. GPS position sensor. The waste bin sensor determines if any measured data requires that a user alert be sent. If any measured data requires that a user alert be sent, then a user alert is sent. The waste bin sensor then waits for an interval, before making measurements again. If no measured data requires that a user alert be sent, then the waste bin sensor then waits for an interval, before making measurements again. FIG. 12 shows an example of a method of operation of a waste bin sensor.

9) Box Sensor (e.g. Moeco Test Box Sensor)

In an example, a box sensor (e.g. Moeco test box sensor) includes a sticker-like sensor that can be attached to a box, the box including a condition-sensitive filling, in which the sensor logs data about the box's storage conditions and a whole life cycle of the sensor. The main goal of this sensor device is to help manufacturers of condition-sensitive products to collect physical data from boxes and to aggregate the collected data for further analysis.

In an example, the box sensor (e.g. Moeco box sensor) collects data about external temperature and humidity, light brightness, and detects movement and can detect if the box has been picked up e.g. by a person.

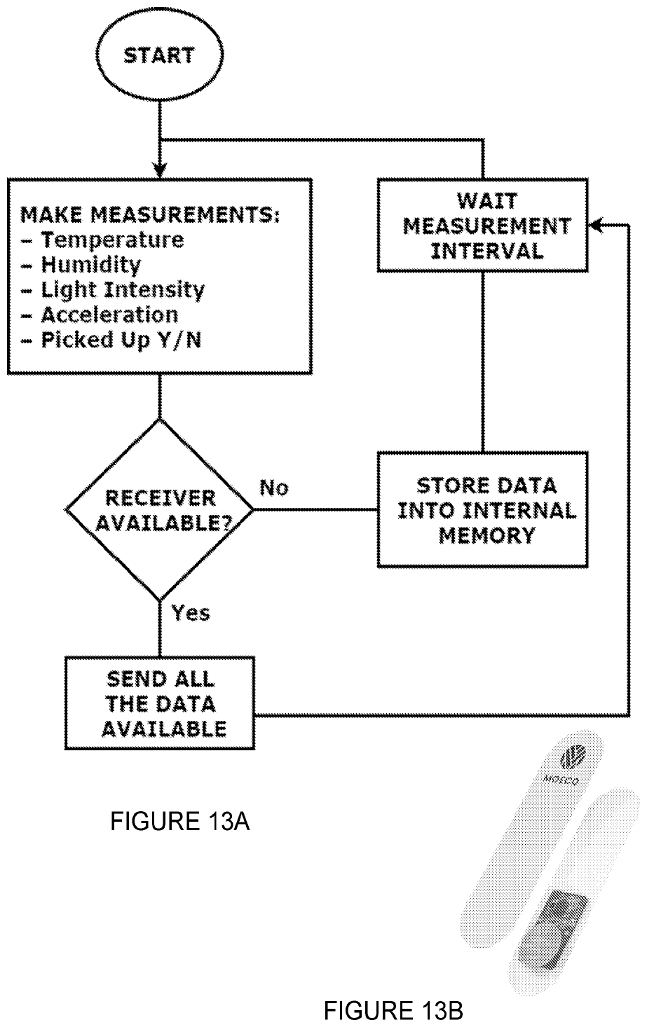

In an example operation of a box sensor, the box sensor makes sensory measurements using its sensors, the measurements including one or more of, or all of: temperature measurement using temperature sensor; humidity measurement using humidity sensor; light intensity using light intensity sensor; acceleration, using acceleration sensor; picked-up sensor using pick-up sensor. The box sensor determines if a receiver is available for transmitting as-yet not transmitted sensor data to a server. If no receiver is available, the sensory data is stored in memory of the box sensor. The box sensor then waits for an interval, before making measurements again. If a receiver is available, available and/or stored data is sent to the server. The box sensor then waits for an interval, before making measurements again. FIG. 13A shows an example of a method of operation of a box sensor. In an example of a box sensor, the box sensor includes a PCB and a battery within the box sensor interior. FIG. 13B shows an exploded view of an example of a box sensor, in which the box sensor includes a PCB and a battery within the box sensor interior.

10) Window Sensor (e.g. Moeco Window Sensor)

In an example, a window sensor (e.g. Moeco window sensor) integrates into a window to collect data about the window's operating conditions. The window sensor may count the number of openings and closings of a window, it may check the external and internal temperature and humidity and it may be powered by a solar panel. Generated sensory data may help window manufacturers to estimate real life-time window durability and provides them with the location of their windows.

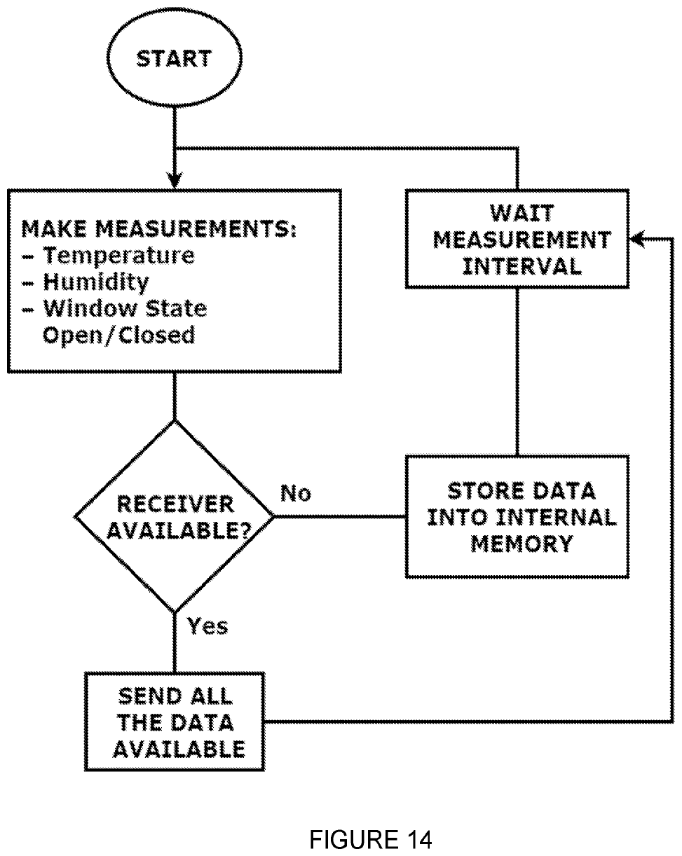

In an example operation of a window sensor, the window sensor makes sensory measurements using its sensors, the measurements including one or more of, or all of: position measurement using position sensor e.g. GPS position sensor; temperature measurement using temperature sensor; humidity measurement using humidity sensor; light intensity using light intensity sensor; acceleration, using acceleration sensor; window state (e.g. window open, window closed) using window open sensor. In an example operation of a window sensor, the window sensor makes sensory measurements using its sensors, the measurements including one or more of, or all of: temperature measurement using temperature sensor; humidity measurement using humidity sensor; window state (e.g. window open, window closed) using window open sensor. The window sensor determines if a receiver is available for transmitting as-yet not transmitted sensor data to a server. If no receiver is available, the sensory data is stored in memory of the window sensor. The window sensor then waits for an interval, before making measurements again. If a receiver is available, available and/or stored data is sent to the server. The window sensor then waits for an interval, before making measurements again. FIG. 14 shows an example of a method of operation of a window sensor.

11) Smart City Sensor (e.g. Moeco Smart City Sensor)

In an example, a smart city sensor (e.g. Moeco smart city sensor) is a sensor for measuring environmental conditions in a city. It includes a microphone, accelerometer and thermometer. It measures noise level, vibration and current temperature. The sensor may have a sticker-like body with thickness around 4 mm and is protected from rain; the sensor can be easily attached to city infrastructure objects and has a solar-powered battery.

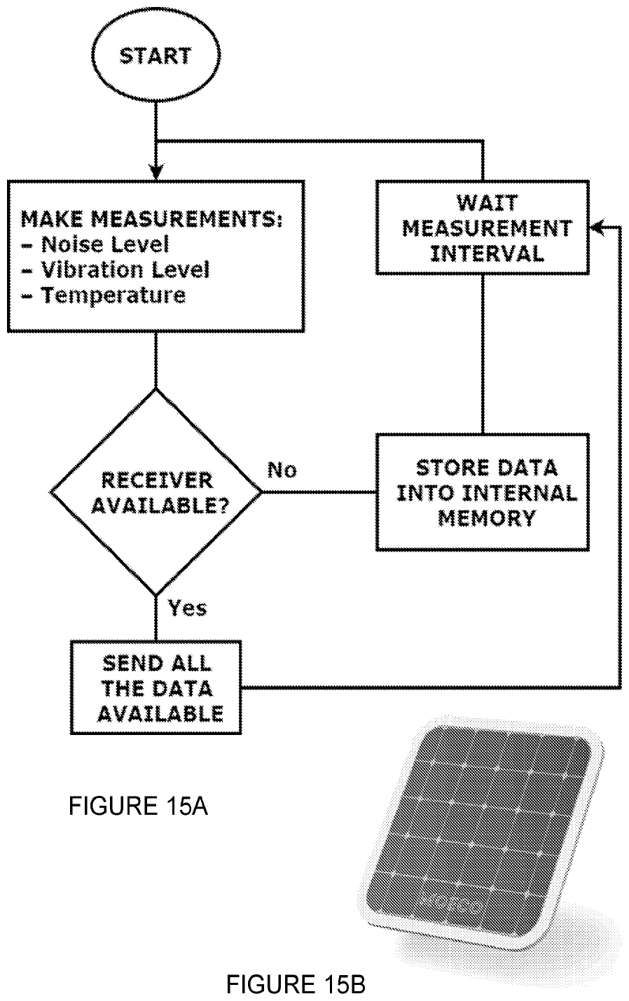

In an example operation of a smart city sensor, the smart city sensor makes sensory measurements using its sensors, the measurements including one or more of, or all of: noise level using a microphone; vibration measurement using vibration sensor; temperature measurement using temperature sensor; humidity measurement using humidity sensor; light intensity using light intensity sensor. In an example operation of a smart city sensor, the smart city sensor makes sensory measurements using its sensors, the measurements including one or more of, or all of: noise level using a microphone; vibration measurement using accelerometer; temperature measurement using temperature sensor. The smart city sensor determines if a receiver is available for transmitting as-yet not transmitted sensor data to a server. If no receiver is available, the sensory data is stored in memory of the smart city sensor. The smart city sensor then waits for an interval, before making measurements again. If a receiver is available, available and/or stored data is sent to the server. The smart city sensor then waits for an interval, before making measurements again. FIG. 15A shows an example of a method of operation of a smart city sensor. FIG. 15B shows an example of a smart city sensor.

12) Toothpaste Tube Sensor (e.g. Moeco Toothpaste Tube Sensor)

In an example, a toothpaste tube sensor (e.g. Moeco toothpaste tube sensor) measures the amount of toothpaste left in a tube. It helps manufacturers to understand the usage of their product and the amount of wasted toothpaste.

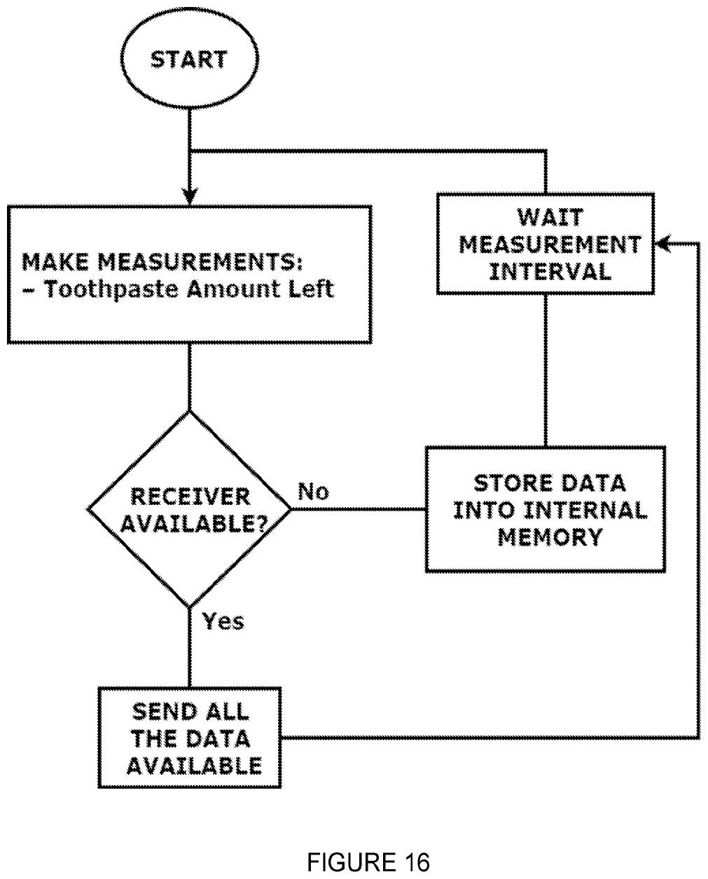

In an example operation of a toothpaste tube sensor, the toothpaste tube sensor makes sensory measurements using its sensors, the measurements including: measuring toothpaste amount left. The toothpaste tube sensor determines if a receiver is available for transmitting as-yet not transmitted sensor data to a server. If no receiver is available, the sensory data is stored in memory of the toothpaste tube sensor. The toothpaste tube sensor then waits for an interval, before making measurements again. If a receiver is available, available and/or stored data is sent to the server. The toothpaste tube sensor then waits for an interval, before making measurements again. FIG. 16 shows an example of a method of operation of a toothpaste tube sensor.

13) Mouthwasher Sensor (e.g. Moeco Mouthwasher Sensor)

In an example, a mouthwasher sensor (e.g. Moeco Mouthwasher sensor) measures the amount of liquid left in a container (e.g. a tube). It has two versions—an ultrasonic sensor for the bottle cap and a pressure sensor for a bottle's bottom. It helps manufacturers to understand the usage of their products.

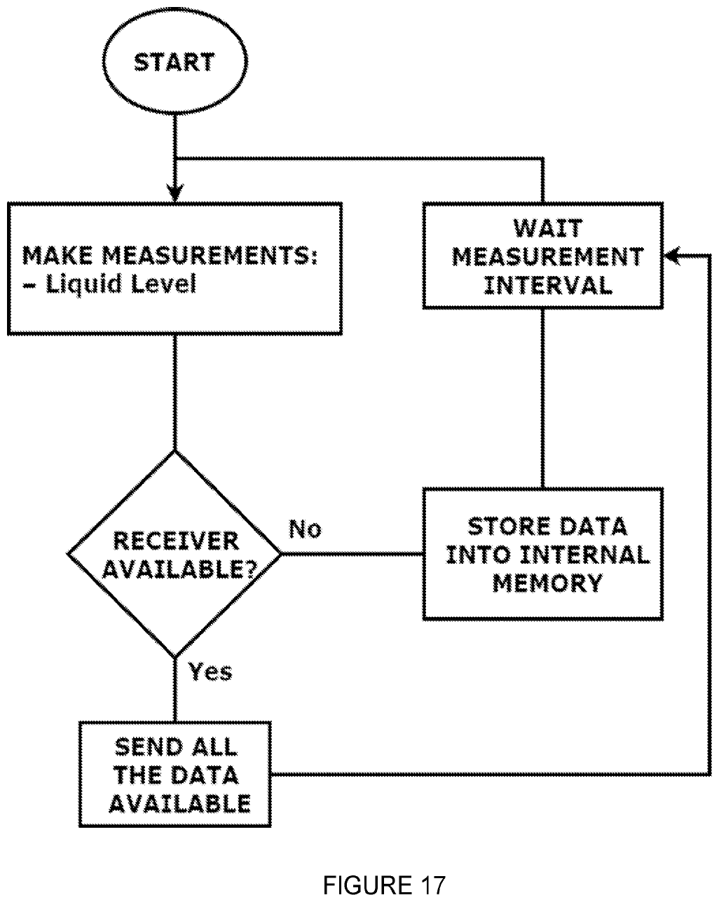

In an example operation of a mouthwasher sensor, the mouthwasher sensor makes sensory measurements using its sensors, the measurements including: measuring liquid amount left, e.g. measuring liquid level. The mouthwasher sensor determines if a receiver is available for transmitting as-yet not transmitted sensor data to a server. If no receiver is available, the sensory data is stored in memory of the mouthwasher sensor. The mouthwasher sensor then waits for an interval, before making measurements again. If a receiver is available, available and/or stored data is sent to the server. The mouthwasher sensor then waits for an interval, before making measurements again. FIG. 17 shows an example of a method of operation of a mouthwasher sensor.

14) Revolution Sensor (e.g. Moeco Revolution Sensor)

In an example, a revolution sensor may be configured as a tube sensor (e.g. Moeco tube sensor), which uses an accelerometer for counting amount of revolutions in a rotatable object, e.g. which doesn't make turns often. It can be used to count the amount of material left in a single roll and it can be fixed to a roll's tube.

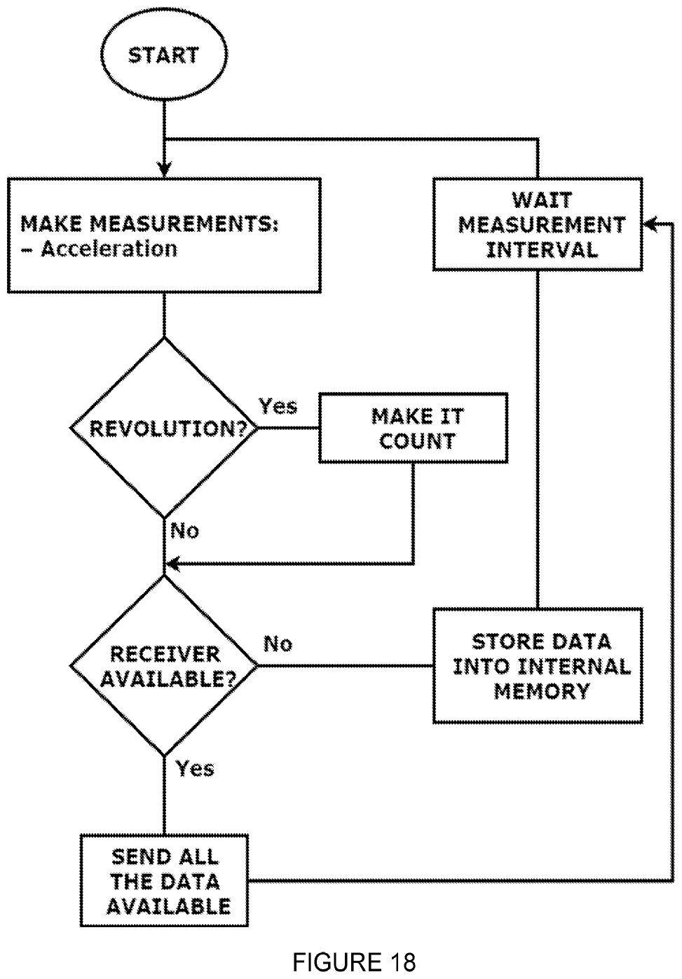

In an example operation of a revolution sensor, the revolution sensor makes sensory measurements using its sensors, the measurements including: measuring acceleration using an accelerometer. If a revolution is detected, then a count of the revolution is recorded. The revolution sensor determines if a receiver is available for transmitting as-yet not transmitted sensor data to a server. If no receiver is available, the sensory data is stored in memory of the revolution sensor. The revolution sensor then waits for an interval, before making measurements again. If a receiver is available, available and/or stored data is sent to the server. The revolution sensor then waits for an interval, before making measurements again. FIG. 18 shows an example of a method of operation of a revolution sensor.

15) Paper Dispenser Sensor (e.g. Moeco Paper Dispenser Sensor)

In an example, a paper dispenser sensor (e.g. Moeco paper dispenser sensor) is a device that counts the amount (e.g. the number) of paper towels left in a paper towel dispenser. It may use an ultrasonic sensor and helps to reduce loading on maintenance staff by alerting when the dispenser is getting low.

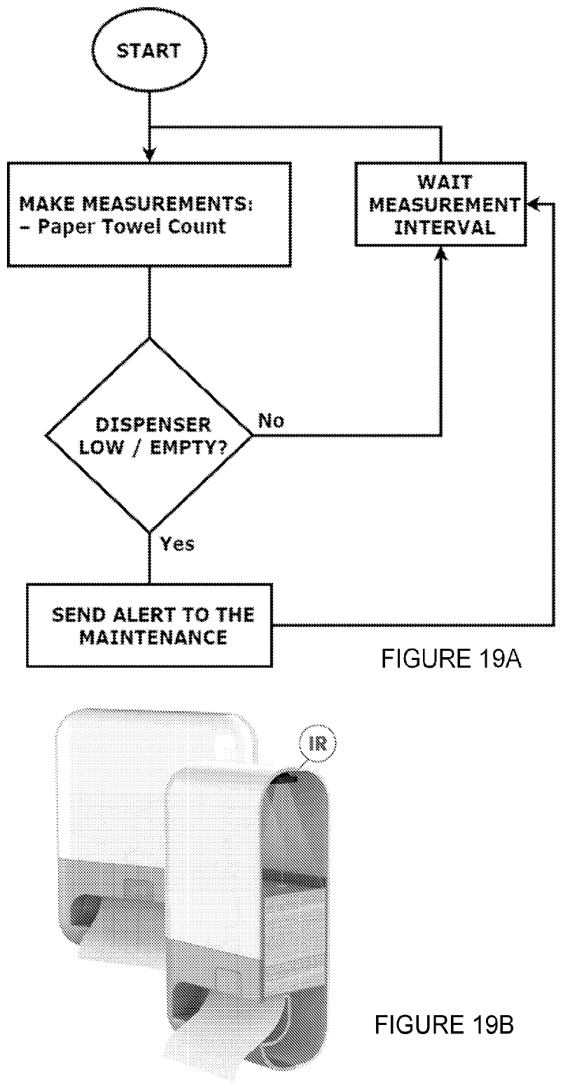

In an example operation of a paper dispenser sensor, the paper dispenser sensor makes sensory measurements using its sensors, the measurements including: measuring paper towel amount or count. The paper dispenser sensor determines if the dispenser is low or empty. If the paper dispenser sensor determines the dispenser is not low or empty, the paper dispenser waits for an interval, before making measurements again. If the paper dispenser sensor determines the dispenser is low or empty, the paper dispenser sends an alert to maintenance. The paper dispenser waits for an interval, before making measurements again. FIG. 19A shows an example of a method of operation of a paper dispenser sensor. In an example of a paper dispenser, the paper dispenser includes an infra red (IR) source and detector, arranged to detect a height of a stack of paper. FIG. 19B shows an example of a paper dispenser, the paper dispenser including an infra red (IR) source and detector, arranged to detect a height of a stack of paper. The left side of FIG. 19B shows the paper dispenser in normal operation. The right side of FIG. 19B shows a vertical cross section of the paper dispenser, in normal operation.

16) Medical Storage Sensor (e.g. Moeco Medical Storage Sensor)

In an example, a medical storage sensor (e.g. Moeco medical storage sensor) is a temperature and humidity sensor e.g. in an IP67 casing, which also tracks its own location. The IP Code, or Ingress Protection Code, IEC standard 60529, sometimes interpreted as International Protection Code, classifies and rates the degree of protection provided by mechanical casings and electrical enclosures against intrusion, dust, accidental contact, and water. IP67 means the unit can be dropped into a body of water up to a meter deep for half an hour. Fixed in a container with condition-sensitive medical supplies a medical storage sensor helps to track storage and transport conditions. The medical storage sensor device also has customizable alerts and helps to find dangerous storage or shipping conditions which lead to spoiled supplies.

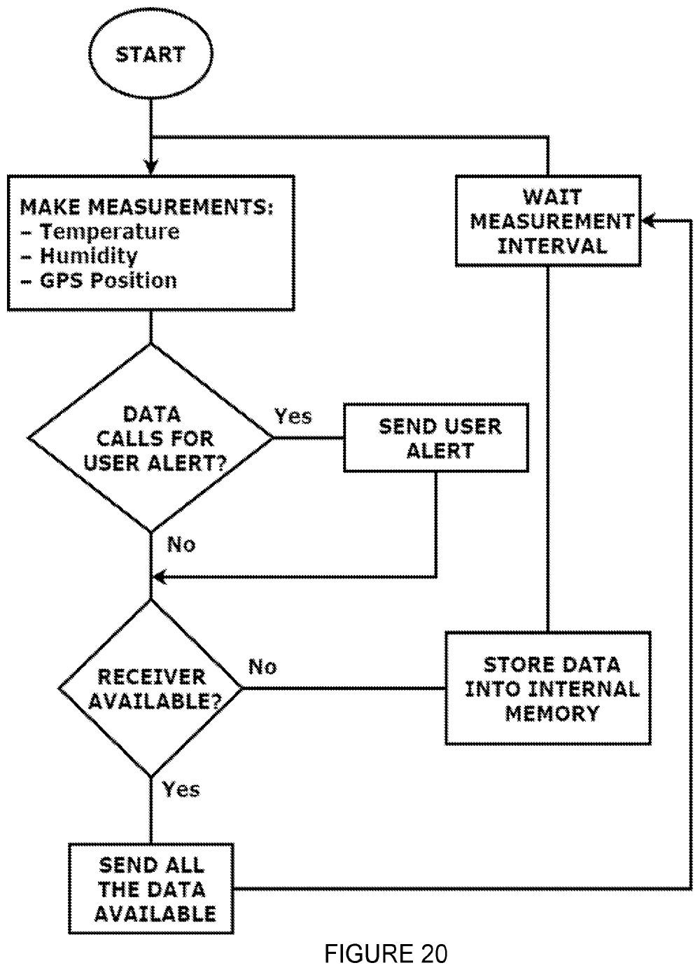

In an example operation of a medical storage sensor, the medical storage sensor makes sensory measurements using its sensors, the measurements including one or more of, or all of: position measurement using position sensor e.g. GPS position sensor; temperature measurement using temperature sensor; humidity measurement using humidity sensor. The medical storage sensor determines if the sensor data requires a user alert to be sent. If the medical storage sensor determines that the sensor data requires a user alert to be sent, then a user alert is sent. The medical storage sensor determines if a receiver is available for transmitting as-yet not transmitted sensor data to a server. If no receiver is available, the sensory data is stored in memory of the medical storage sensor. The medical storage sensor then waits for an interval, before making measurements again. If a receiver is available, available and/or stored data is sent to the server. The medical storage sensor then waits for an interval, before making measurements again. FIG. 20 shows an example of a method of operation of a medical storage sensor.

17) Laser Tachometer Sensor (e.g. Moeco Laser Tachometer)

In an example, a laser tachometer sensor (e.g. Moeco laser tachometer) collects data about an operating cycle of a fast spinning tool and has customizable alerts if the tool's revolutions per minute (rpm) goes beyond predefined limits. The laser tachometer sensor doesn't require any physical contact with a working tool and can be placed in a line of sight of a working tool. The laser tachometer sensor helps to find a tool's real life-time durability as well as prevent different accidents.

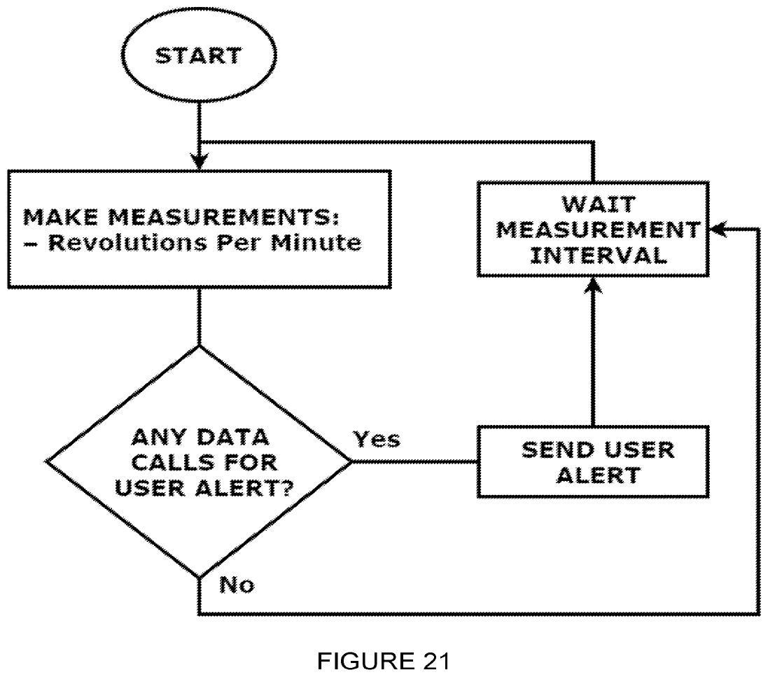

In an example operation of a laser tachometer sensor, the laser tachometer sensor makes sensory measurements using its sensors, the measurements including: measuring revolutions per minute. The revolutions per minute data is measured, and the sensor determines using the measured data if a user alert needs to be generated. If the sensor determines using the measured data that a user alert needs to be generated, then a user alert is sent. The laser tachometer sensor then waits for an interval, before making measurements again. FIG. 21 shows an example of a method of operation of a laser tachometer sensor.

18) Flow Sensor (e.g. Moeco Flow Sensor)

In an example, a flow sensor (e.g. Moeco flow sensor) is a device for industrial pipes and helps to prevent different pump accidents by generating customizable alerts. The flow sensor tracks an internal flow temperature, flow speed and external pipe vibrations, as well as a pump's consumed power. The flow sensor can also reduce the cost of maintaining the pump by reducing the number of pump inspections.

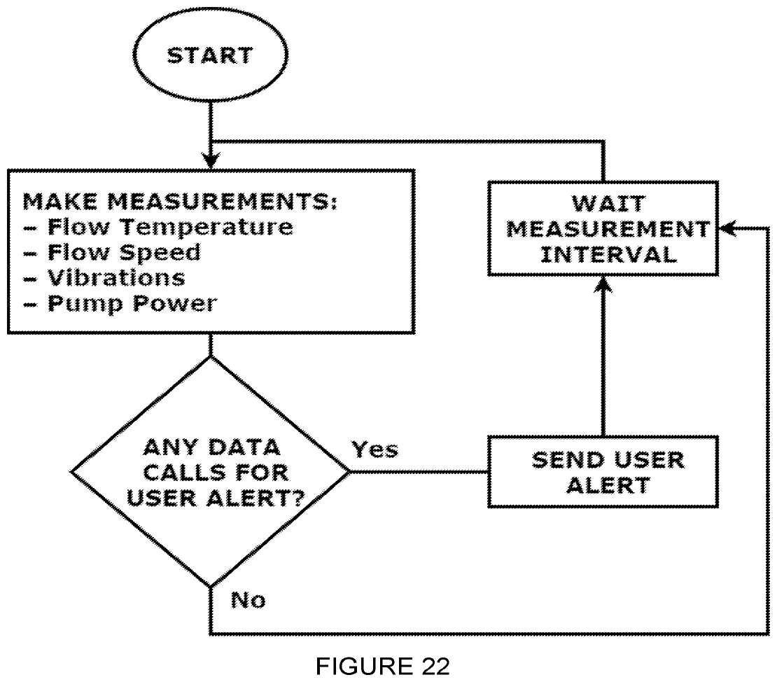

In an example operation of a flow sensor, the flow sensor makes sensory measurements using its sensors, the measurements including one or more, or all, of: measuring flow temperature using a temperature sensor; measuring flow speed using a flow speed sensor; measuring vibrations using a vibration sensor; measuring pump power using a power sensor. The sensory data is measured, and the sensor determines using the measured data if a user alert needs to be generated. If the sensor determines using the measured data that a user alert needs to be generated, then a user alert is sent. The flow sensor then waits for an interval, before making measurements again. FIG. 22 shows an example of a method of operation of a flow sensor.

19) Log Sensor (e.g. Moeco Log Sensor)

In an example, a log sensor (e.g. Moeco log sensor) device is used for finding damage to wooden logs. It includes a speaker and a microphone which are placed respectively on the log's two ends. The speaker sends a sound signal and depending on a signal received by a microphone the device can estimate internal wood damage.

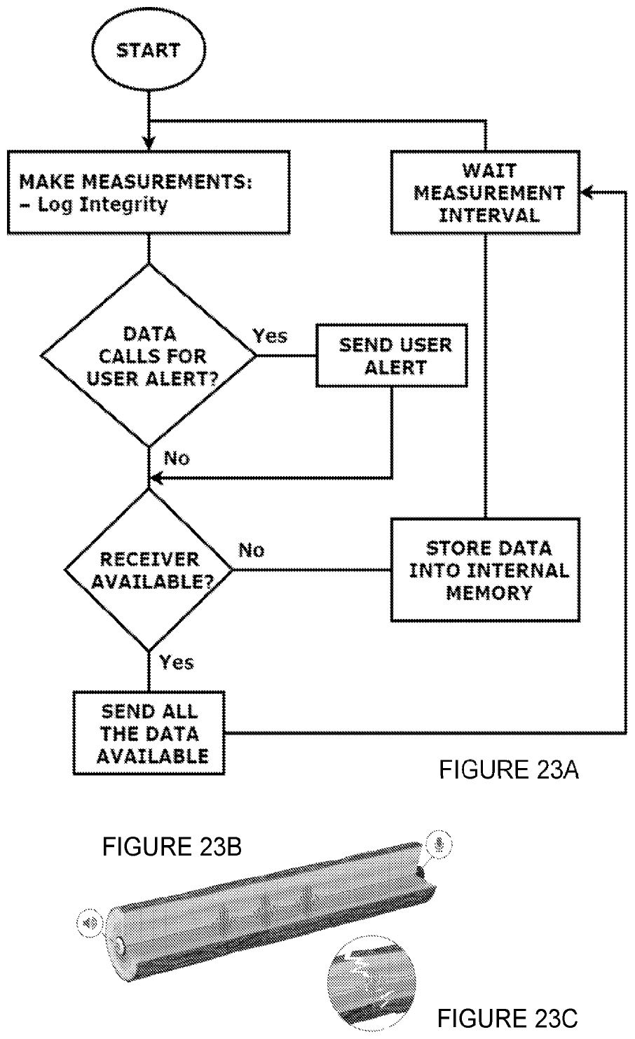

In an example operation of a log sensor, the log sensor makes sensory measurements using its sensors, to measure a log's integrity. The sensory data is measured, and the sensor determines using the measured data if a user alert needs to be generated. If the sensor determines using the measured data that a user alert needs to be generated, then a user alert is sent. The log sensor determines if a receiver is available for transmitting as-yet not transmitted sensor data to a server. If no receiver is available, the sensory data is stored in memory of the log sensor. The log sensor then waits for an interval, before making measurements again. If a receiver is available, available and/or stored data is sent to the server. The log sensor then waits for an interval, before making measurements again. FIG. 23A shows an example of a method of operation of a log sensor.

In an example, a log sensor device includes a speaker and a microphone, the speaker and the microphone in wireless communication with each other. The speaker is attached to one end of a log and emits sound into the log. The microphone is attached to the opposite end of the log to the speaker. The microphone detects sound emitted by the speaker which is transmitted by the log, and detected sound data is generated by the microphone. The microphone is configured to process the detected sound data to determine the integrity of the log e.g. to determine if the log is defect-free or if the log is defective. FIG. 23B shows an example of a log sensor device including a speaker and a microphone, the speaker and the microphone in wireless communication with each other; the speaker is attached to one end of a log and emits sound into the log; the microphone is attached to the opposite end of the log to the speaker. FIG. 23C shows an example of a highly defective portion of a log.

In an example, a log sensor device includes a speaker and a microphone, the speaker and the microphone in wired communication with each other. The speaker is attached to one end of a log and emits sound into the log. The microphone is attached to the opposite end of the log to the speaker. The microphone detects sound emitted by the speaker which is transmitted by the log, and detected sound data is generated by the microphone. The microphone is configured to process the detected sound data to determine the integrity of the log e.g. to determine if the log is defect-free or if the log is defective.

### NOTE

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A system for tracking a life cycle of a device, the system including a server system, a plurality of gateways and the device, the device configured to sense and to transmit sensory data, the device including a sensor and a transmitter, wherein the server system is configured to receive transmissions from the device via any gateway of the plurality of gateways, the transmissions including a device ID of the device, the server system storing a tracking record of the device in association with the device ID, wherein the server system is configured to update the stored tracking record of the device in relation to:
(i) production of the device, in response to receiving a respective communication from the device; and
(ii) storage or sale of the device, in response to receiving a respective communication from the device; and
(iii) usage of the device, in response to receiving a respective communication from the device.

2. The system of claim 1, wherein the server system is configured to update the stored tracking record of the device in relation to: (i) production of the device, in response to receiving a respective communication from the device, via a gateway associated with device production; or
wherein the server system is configured to update the stored tracking record of the device in relation to: (ii) storage or sale of the device, in response to receiving a respective communication from the device, via a gateway associated with storage or sale of the device; or
wherein the server system is configured to update the stored tracking record of the device in relation to: (iii) usage of the device, in response to receiving a respective communication from the device, via a gateway associated with, or inferred to relate to, device usage.

3-4. (canceled)

5. The system of claim 1, wherein the server system is configured to update the stored tracking record of the device in relation to:
(iv) recycling or decommissioning of the device, in response to receiving a respective communication from the device.

6. The system of claim 5, wherein the server system is configured to update the stored tracking record of the device in relation to:
(iv) recycling or decommissioning of the device, in response to receiving a respective communication from the device, via a gateway associated with device recycling or decommissioning.

7. The system of claim 1, wherein the device transmitter is configured to transmit sensory data using any one, or more, or all, of the following technologies for data transfer: WiFi, Bluetooth, low-power wide-area network (LPWAN) or Global System for Mobile Communications (GSM)/Narrowband Internet of Things (NB-IoT); or
wherein a gateway is configured to receive sensory data using any one, or more, or all, of the following technologies for data transfer: WiFi, Bluetooth, low-power wide-area network (LPWAN) or Global System for Mobile Communications (GSM)/Narrowband Internet of Things (NB-IoT).

8. (canceled)

9. The system of claim 1, wherein transmitted data is aggregated by the gateways, wherein the gateways then transfer data to the server system; or
wherein the server system receives data from the gateways, through middleware.

10. (canceled)

11. The system of claim 1, wherein the device includes a plurality of sensors.

12. The system of claim 11, wherein sensory data is generated by different physical sensors in the device.

13. The system of claim 1, wherein the device includes a PCB; or
wherein the device includes a battery; or
wherein the device includes a processor.

14-15. (canceled)

16. The system of claim 1, wherein the server system provides access to sensory data it has received.

17. The system of claim 16, wherein the server system provides the access to the sensory data it has received, through application programming interface (API) interfaces.

18. The system of claim 1, wherein a gateway is a smartphone, programmed with an application.

19-20. (canceled)

21. The system of claim 1, including a device configured to sense and to transmit sensory data, the device including a Bluetooth interface, the device configured to send data using the Bluetooth interface to a Bluetooth gateway that forwards data to the server system; or
including a device configured to sense and to transmit sensory data, and configured with LoRa (Long Range) technology, and configured to send data to LPWAN gateways, that forward data to the server system; or
including a device configured to sense and to transmit sensory data, the device supporting WiFi communications, the device configured to send data via a regular WiFi router, or using premises-based software gateways, that forward data to the server system; or
including a device configured to sense and to transmit sensory data, the device supporting GSM and/or Narrow Band communications, the device configured to send data to a mobile operator's cloud which is also connected to the server system.

22-24. (canceled)

25. The system of claim 1, wherein the device configured to sense and to transmit sensory data is a portable device; or
wherein the device configured to sense and to transmit sensory data is a handheld device; or
wherein the device configured to sense and to transmit sensory data includes a touch screen.

26-27. (canceled)

28. The system of claim 1, the system including a plurality of sensor devices which collect sensor data (e.g. temperature, location or acceleration data), and which transmit the collected data to gateways e.g. via one or more of WiFi, Bluetooth, LPWAN or GSM/NB-IoT communications.

29. The system of claim 1, wherein gateways transmit the received collected data to the server system, wherein the server system comprises a gateway API, a synchronization server and a database server, wherein the gateways transmit the received collected data to the gateway API, which stores the received data using a blockchain system using the synchronization server, where the data is then stored as a structured query language (SQL) database (DB) on a database server.

30. The system of claim 1, wherein the server system performs integrations to payments gateways.

31. The system of claim 1, wherein the server system includes APIs eg. to a cloud system, to a custom system, or to provide data views.

32. The system of claim 31, wherein the APIs eg. to a cloud system, to a custom system, or to provide data views, connect to 3^{rd} side data analysis engines, or to stand alone solutions.

33. The system of claim 1, wherein the server system provides a web view in connection with a web application.

34. The system of claim 1, wherein the server system is configured such that during data processing, the server system recognizes a life cycle stage of the sensor which sent the data; or
wherein the server system is configured to track a full life cycle of a device; or
wherein the server system is configured to customize the life cycle stages of a device.

35-36. (canceled)

37. The system of claim 1, including a newly-produced device, configured to sense and to transmit sensory data, which is configured such that after power-up, the device communicates with a local gateway, and provides a unique device ID in a communication via the gateway.

38. The system of claim 37, wherein the newly-produced device communicates a location; or
wherein the newly-produced device communicates a location, and wherein the communicated location is used by the server system to establish, or to confirm, that the device is newly produced; or
wherein the gateway sends a transmission to the server system, wherein the transmission identifies the gateway; or
wherein the server system is configured to identify the newly produced device using its unique device ID, and a record at the server system is created, or is updated, for tracking this newly produced device through its life cycle; or
wherein the identity of the gateway is used to establish, or to confirm, that the device is newly produced; or
wherein the device is configured (e.g. programmed) to communicate that it is newly-produced, or newly manufactured.

39-43. (canceled)

44. The system of claim 1, wherein the device configured to sense and to transmit sensory data communicates with a local gateway, and provides its unique device ID in a communication via the gateway.

45. The system of claim 44, wherein the device communicates a location.

46. The system of claim 45, wherein the communicated location is used to establish, or to confirm, that the device is at a place of storage, or at a place of sale; or
wherein the communicated location is used to establish, or to confirm, that the device is no longer at a place of storage, or at a place of sale, or at a place of manufacture, and hence it is now being used, and hence the record for tracking this device is updated to reflect that it is being used; or
wherein the gateway sends a transmission to the server system, wherein the transmission may identify the gateway; or
wherein the server system identifies the device using its unique device ID, and its previously created record for tracking this device through its life cycle is updated; or
wherein the identity of the gateway is used to establish, or to confirm, that the device is no longer at a place of storage, or at a place of sale, or at a place of manufacture, and hence it is now being used, and hence the record for tracking this device is updated to reflect that it is being used; or
wherein the device is configured (e.g. programmed) to communicate that it is being used; or
wherein the communicated location is used to establish, or to confirm, that the device is at a recycling location or at a decommissioning location, and hence it is now being recycled or decommissioned, and hence the record for tracking this device is updated to reflect that it is being recycled or decommissioned; or
wherein the server system identifies the device using its unique device ID, and its previously created record for tracking this device through its life cycle is updated; or
wherein the identity of the gateway is used to establish, or to confirm, that the device is at a recycling location or at a decommissioning location, and hence it is now being recycled or decommissioned, and hence the record for tracking this device is updated to reflect that it is being recycled or decommissioned; or
wherein the device is configured (e.g. programmed) to communicate that it is being recycled or decommissioned.

47. The system of claim 44, wherein the gateway sends a transmission to the server system, wherein the transmission may identify the gateway; or
wherein the server system identifies the device using its unique device ID, and its previously created record for tracking this device through its life cycle is updated; or
wherein the identity of the gateway is used to establish, or to confirm, that the device is at a place of storage, or at a place of sale; or
wherein the device is configured (e.g. programmed) to communicate that it is being stored, or is being put on sale.

48-59. (canceled)

60. The system of claim 1, wherein the server system provides a user interface in which data is displayed relating to tracking the life cycle of a product, e.g. from production to storing, selling, using and then to recycling, of the product.

61-67. (canceled)

68. The system of claim 1, wherein the device configured to sense and to transmit sensory data is a logistic sensor device, the device including a temperature sensor, a light intensity sensor or sensors, and an acceleration sensor, the device configured to make sensory measurements using its sensors, the measurements including a temperature measurement using the temperature sensor, a light intensity measurement using the light intensity sensor, and an acceleration measurement, using the acceleration sensor, wherein the device is configured to send sensor data to a server.

69-80. (canceled)

81. The system of claim 1, wherein the device configured to sense and to transmit sensory data is a security seal sensor device including a seal, the device including one or more sensors, the security seal sensor arranged to make sensory measurements using its sensors, the measurements checking if the seal was broken, wherein if measured data is such that the seal is determined to be broken, then a user alert is sent.

82-116. (canceled)

117. The system of claim 1, wherein the device configured to sense and to transmit sensory data is a box sensor device, the device attachable to a box, the device including a temperature sensor, a light sensor or sensors, an acceleration sensor and a humidity sensor, the device configured to make sensory measurements using its sensors, the measurements including a temperature measurement using the temperature sensor, a light intensity measurement using the light intensity sensor, an acceleration measurement using the acceleration sensor, and a humidity measurement using humidity sensor, wherein the device is configured to send sensor data to a server.

118-166. (canceled)

167. The system of claim 1, wherein the device configured to sense and to transmit sensory data is a medical storage sensor device, the device including a position sensor (e.g. GPS position sensor), a temperature sensor and a humidity sensor, the device including a water-resistant casing.

168-187. (canceled)
